(19) United States
(12) Patent Application Publication
(10) Pub. No.: US 2009/0019188 A1
(43) Pub. Date: Jan. 15, 2009

(54) PROCESSING INPUT FOR COMPUTING SYSTEMS BASED ON THE STATE OF EXECUTION

(75) Inventors: Harold E. Mattice, Gardnerville, NV (US); Christian E. Gadda, Las Vegas, NV (US); Chauncey W. Griswold, Reno, NV (US); Richard L. Wilder, Sparks, NV (US); James W. Stockdale, Clio, CA (US)

Correspondence Address: Weaver Austin Villeneuve & Sampson LLP - IGT;Attn: IGT, P.O. Box 70250, Oakland, CA, 94612-0250, US

(73) Assignee: IGT, Reno, NV (US)

(21) Appl. No.: 11/776,434

(22) Filed: Jul. 11, 2007

(51) Int. Cl. G06F 3/00

(52) U.S. Cl. 710/17

(57) ABSTRACT

Techniques for processing input based on the execution state of computer programs are disclosed. One or more discreet locations (e.g., points, areas, regions, surfaces) of the input device can be effectively selected for an execution state of an instance of computer program code. Only the selected input locations of input devices including those capable of receiving multiple input need to be monitored for input. Input is detected and effectively filtered for visually-based input devices (e.g., touch screens). A visual image representing the input surfaces (or areas) of the input device can be captured as graphics data (e.g., graphics data captured by a camera). Moreover, the captured image can be effectively filtered by only processing the portions of the graphics data that correspond or represent the selected input locations of the input device (i.e., the selected input locations for the current state of execution). One or more Inferred (IR) sources are configured to emit controlled IR light for a multi-touch screen. The IR light can be effectively trapped within the surfaces of the touch screen, whereby the presence of an object that comes in close proximity and/or contact with the touch screen surface disturbs the controlled IR light and causes it to diverge out of the surfaces of the touch screen so that it can be captured by an IR detection mechanism (e.g., a camera). One or more portions of the graphics data captured by the IR detection mechanism are then analyzed to detect the presence of a physical object provided as input. As such, relatively more sophisticated detection mechanism can be utilized and/or system performance can be improved. Input detection mechanisms can be effectively tuned to account for various conditions including wear and tear of the input surfaces.

### BACKGROUND OF THE INVENTION

In computer (or computing) science, input/output (or I/O) can refer to a collection of interfaces that different functional units (sub-systems) of an information processing system use to communicate with each other. In general, Input can be a signal received by a functional unit, and output can be a signals sent from the functional unit.

Input/output (I/O) devices can be used by a person (or other system) to communicate with a computer. For instance, keyboards and mouses are considered input devices of a computer and monitors and printers are considered output devices of a computer. Typically, devices used for communication between computers are for both input and output (e.g., modems and network cards).

Some input devices (e.g., mouses and keyboards) can receive as input the physical movement provided by a human being and convert it into signals that a computer can understand. The output from these devices is treated as input by the computer. Similarly, printers and monitors take as input signals that a computer outputs and convert them into representations that human users can see or read (the process of reading or seeing the representations can be considered as receiving input.)

Generally, an input device can be considered an interface between a user (e.g., human being, application program) and a machine. The input device's primary function is to receive input from the user and translate it for the machine. A few examples of Input devices are keyboards, mouses, touchpads, touch screens, trackballs and tablets. Input devices are prevalent in gaming environments. Joysticks, gamepads, power pads and analog sticks are examples of input devices that are often used in gaming environments.

Some devices can effectively provide both input and output. As an example, conventional touch screens (touch screens, touch panels or touch screen panels) are display overlays which have the ability to display and receive information on the same screen. The effect of such overlays allows a display to be used as an input device, removing the keyboard and/or the mouse as the primary input device for interacting with the display's content. Such displays can be attached to computers or, as terminals, to networks. Touch screens also have assisted in recent changes in the PDA and Cell-Phone Industries, making these devices more usable. Touchscreens have become commonplace since the invention of the electronic touch interface in 1971 by Dr. Samuel C. Hurst. They have become familiar in retail settings, on point of sale systems, on ATMs and on PDAs where a stylus is sometimes used to manipulate the GUI and to enter data. The popularity of smart phones, PDAs, portable game consoles and many types of information appliances is driving the demand for, and the acceptance of, touchscreens.

More recently, “multi-touching” techniques have been developed. Generally, “multi-touch” can refer to a human-computer interaction technique and the hardware devices that implement it. For example, it can refer to a touch screen (or touch tablet/touchpad) that recognizes multiple simultaneous touch points. The multi-touch screen can be configured to detect the pressure or degree of each touch independently, as well as detecting their individual position. This allows gestures and interaction with multiple fingers or hands, chording, and can provide rich interaction, including direct manipulation, through intuitive gestures. Depending largely on their size, some multi-touch devices support more than one user on the same device simultaneously. One salient aspect of this technique is that it makes easy to zoom in or out in a Zooming User Interface with two fingers, for example, thereby providing a more direct mapping than with a single-point device like a mouse or stylus. Touchscreens (touch screens, touch panels or touchscreen panels) are display overlays which have the ability to display and receive information on the same screen. The effect of such overlays allows a display to be used as an input device, removing the keyboard and/or the mouse as the primary input device for interacting with the display's content. Such displays can be attached to computers or, as terminals, to networks. Touchscreens also have assisted in recent changes in the PDA and Cell-Phone Industries, making these devices even more usable.

As noted above, input devices are prevalent in gaming environments. Techniques for processing input have become even more important for modern gaming environments which can be configured to operate with various input devices. As such, a modern gaming machine is discussed further.

Typically, a gaming machine utilizes a master controller to effectively control various combinations of devices that allow a player to play a game on the gaming machine and also encourage game play on the gaming machine. A game played on a gaming machine usually requires a player to input money or indicia of credit into the gaming machine, indicate a wager amount, and initiate playing a game of chance. These steps require the gaming machine to control input devices, such as bill validators and coin acceptors, to accept money into the gaming machine and recognize user inputs from devices, including key pads, button pads, card readers, and ticket readers, to determine the wager amount, and initiate game play. After game play has been initiated, the gaming machine determines the outcome of the game, presents the game outcome to the player and may dispense an award of some type depending on the outcome of the game. The operations described above may be carried out on the gaming machine when the gaming machine is operating as a “stand alone” unit and/or linked in a network of some type to a group of gaming machines.

As technology in the gaming industry progresses, more and more gaming services are being provided to gaming machines via communication networks that link groups of gaming machines to a remote computer, such as a host server, that provides one or more gaming services. As an example, gaming services that may be provided by a remote computer to a gaming machine via a communication network of some type include player tracking, accounting, cashless award ticketing, lottery, progressive games, and bonus games or prizes. These services and features are provided in addition to the games that are available for play on the gaming machines.

### SUMMARY OF THE INVENTION

Broadly speaking, the invention relates to processing input for computing systems. In accordance with one embodiment of the invention, input is effectively processed based on the execution state (or stage) of an instance of computer program code being executed (execution instance) by a computing system. Input can be provided (e.g., entered by a human being) via an input device configured to receive input in connection with the execution instance. In accordance with one embodiment of the invention, one or more discreet locations (e.g., points, areas, regions, surfaces) of the input device can be effectively selected for an execution state of an instance of computer program code. It will be appreciated that only the input locations that have been selected for a particular state of execution need to be monitored when the computer program is in that particular state of execution. It will also be appreciated that selected input locations can be selected for an input device capable of receiving input at multiple locations at a given time (e.g., a multi-touch screen).

In accordance with another aspect of the invention, input is detected and effectively filtered for a visually-based input device. The visually-based input device can, for example, be an “integrated” input/output device (e.g., touch screen, multi-tough screen). It will be appreciated that a visual image representing the input surfaces (or areas) of the input device can be captured as graphics data (e.g., graphics data captured by a camera). Moreover, the captured image can be effectively filtered by only processing the portions of the graphics data that correspond or represent the selected input locations of the input device (i.e., the selected input locations for the current state of execution) As such, at any time during the execution of a computer program, only the selected locations of a visually-based input device can be monitored to detect the presence of a physical object provided as input (e.g., only the selected locations on a touch screen are monitored to detect the presence of a human finger or other acceptable forms of input provided to the touch screen.

In one embodiment of the invention, one or more Inferred (IR) sources are configured to emit controlled IR light for a multi-touch screen. It will be appreciated that the controlled IR light can be effectively trapped within the surfaces of the touch screen, whereby the presence of an object that comes in close proximity and/or contact with the touch screen surface disturbs the controlled IR light and causes it to diverge out of the surfaces of the touch screen so that it can be captured by an IR detection mechanism (e.g., a camera). One or more portions of the graphics data captured by the IR detection mechanism are then analyzed to detect the presence of a physical object provided as input. In other words, only the data which corresponds to one or more input locations selected based on the state of execution for monitoring need to be analyzed. As such, relatively more sophisticated detection mechanism can be utilized and/or system performance can be improved. It will be appreciated that the selected graphics data can, for example, be analyzed for the presence of a particular type, form, shape of input, as well as encoded data. An object can, for example, be detected based on the contrast ratio of the captured images. It will also be appreciated that input detection mechanisms can be effectively tuned to account for various conditions including wear and tear of the input surfaces.

The invention can be implemented in numerous ways, including a method, an apparatus, a computer readable medium, a computing device, or a signal embodied in a carrier wave. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing environment in accordance with one embodiment of the invention.

FIG. 1B depicts an input filtering system effectively distributed in a computing environment in accordance with one embodiment of the invention.

FIG. 1C depicts a method for providing input to an execution instance of a computer program via an integrated input/output device in accordance with one embodiment of the invention.

FIG. 2A depicts a visually-based input/output management system in accordance with one embodiment of the invention.

FIG. 2B depicts a multi-touch screen in accordance with one embodiment of the invention.

FIG. 2C depicts a simplified state diagram or state machine in accordance with one embodiment of the invention.

FIG. 2D depicts simplified virtual tables for the virtual reel game in connection to FIGS. 2B and 2C in accordance with one embodiment of the invention.

FIG. 2E depicts a method for providing input/output to a visually-based integrated input/output device in accordance with one embodiment of the invention.

FIG. 3A depicts an IR-based input management system in accordance with one embodiment of the invention.

FIG. 3B depicts a method for processing IR-based input in accordance with one embodiment of the invention.

FIG. 4A depicts a rear projection IR input filtering system provided for a multi touch screen in accordance with one embodiment of the invention.

FIG. 4B depicts a wedge display multi-touch screen in accordance with one embodiment of the invention.

FIG. 4C depicts an LCD display multi-touch screen in accordance with one embodiment of the invention.

FIG. 5 depicts a method for detecting input based on the IR graphics data in accordance with one embodiment of the invention.

FIG. 6 depicts an exemplary method for determining base IR graphics data for detection of IR input in accordance with one embodiment of the invention.

FIG. 7 depicts a multi-touch screen in a gaming environment in accordance with one embodiment of the invention.

FIG. 8 is block diagram of a gaming machine in communication with a wireless game player.

FIG. 9 is a perspective drawing of a gaming machine having a top box and other devices

FIG. 10 is a block diagram of the internal components of a gaming machine and internal components of a wireless game player.

FIG. 11 is a block diagram of a network of gaming machines and wireless game players.

FIG. 12 illustrates in block diagram format an exemplary network infrastructure.

### DETAILED DESCRIPTION OF THE INVENTION

As noted in the background section, an input device can serve as an interface between a user (e.g., human being, application program) and a machine. The input device's primary functions include receiving input from the user and translating it for the machine. The input can be provided to a computing system in connection with a computer program code that is being executed by the computing system. More particularly, when an instance of computer program code (or execution instance) is being executed, input received via the input device is provided for processing to the execution instance. The input can, for example, be provided (e.g., entered) by a human being.

Conventionally, any input received by the input device is provided to an instance of a computer program code (execution instance) configured to receive the input at runtime when the computer program code is executed. The execution instance can effectively ignore input that is deemed non-responsive. Nonetheless, some processing by the execution instance may be required in order to determine that the input should be ignored. Generally, conventional input processing techniques monitor the entire input area (or surface) of input devices. This approach may hinder the performance of computing systems, especially those that are capable of receiving multi-input (e.g., multi-touch) and may receive input frequently (e.g., a gaming system where input is provided often and/or continuously. The conventional approach to input processing may also be problematic in situations where accuracy of input processing is an important or critical factor because it may not be practical to use more sophistication input detection mechanisms as input may be provided often and in an increasing larger areas that have to be monitored.

Gaming environments provide an example where input processing is an important consideration and accuracy in determining the input is highly desirable. As gaming environment evolve, conventional input processing can significantly hinder the performance of gaming machines and/or result in inaccurate processing of input. These undesirable effects are even more pronounced in modern gaming machines capable of receiving multiple input (e.g., multi-touching) where it is highly desirable to provide a relatively large input area and a variety of options for several different games may be available at a given time. In view of the foregoing, improved input processing techniques are highly desirable.

The invention pertains to techniques for processing input for computing systems. In accordance with one embodiment of the invention, input is effectively processed based on the execution state (or stage) of an instance of computer program code being executed (execution instance) by a computing system. Input can be provided (e.g., entered by a human being) via an input device configured to receive input in connection with the execution instance. In accordance with one embodiment of the invention, one or more discreet locations (e.g., points, areas, regions, surfaces) of the input device can be effectively selected for an execution state of an instance of computer program code. It will be appreciated that only the input locations that have been selected for a particular state of execution need to be monitored when the computer program is in that particular state of execution. It will also be appreciated that selected input locations can be selected for an input device capable of receiving input at multiple locations at a given time (e.g., a multi-touch screen).

In accordance with another aspect of the invention, input is detected and effectively filtered for a visually-based input device. The visually-based input device can, for example, be an “integrated” input/output device (e.g., touch screen, multi-tough screen). It will be appreciated that a visual image representing the input surfaces (or areas) of the input device can be captured as graphics data (e.g., graphics data captured by a camera). Moreover, the captured image can be effectively filtered by only processing the portions of the graphics data that correspond or represent the selected input locations of the input device (i.e., the selected input locations for the current state of execution). As such, at any time during the execution of a computer program, only the selected locations of a visually-based input device can be monitored to detect the presence of a physical object provided as input (e.g., only the selected locations on a touch screen are monitored to detect the presence of a human finger or other acceptable forms of input provided to the touch screen.

In one embodiment of the invention, one or more Inferred (IR) sources are configured to emit controlled IR light for a multi-touch screen. It will be appreciated that the controlled IR light can be effectively trapped within the surfaces of the touch screen, whereby the presence of an object that comes in close proximity and/or contact with the touch screen surface disturbs the controlled IR light and causes it to diverge out of the surfaces of the touch screen so that it can be captured by an IR detection mechanism (e.g., a camera). One or more portions of the graphics data captured by the IR detection mechanism are then analyzed to detect the presence of a physical object provided as input. In other words, only the data which corresponds to one or more input locations selected based on the state of execution for monitoring need to be analyzed. As such, relatively more sophisticated detection mechanism can be utilized and/or system performance can be improved. It will be appreciated that the selected graphics data can, for example, be analyzed for the presence of a particular type, form, shape of input, as well as encoded data. An object can, for example, be detected based on the contrast ratio of the captured images. It will also be appreciated that input detection mechanisms can be effectively tuned to account for various conditions including wear and tear of the input surfaces.

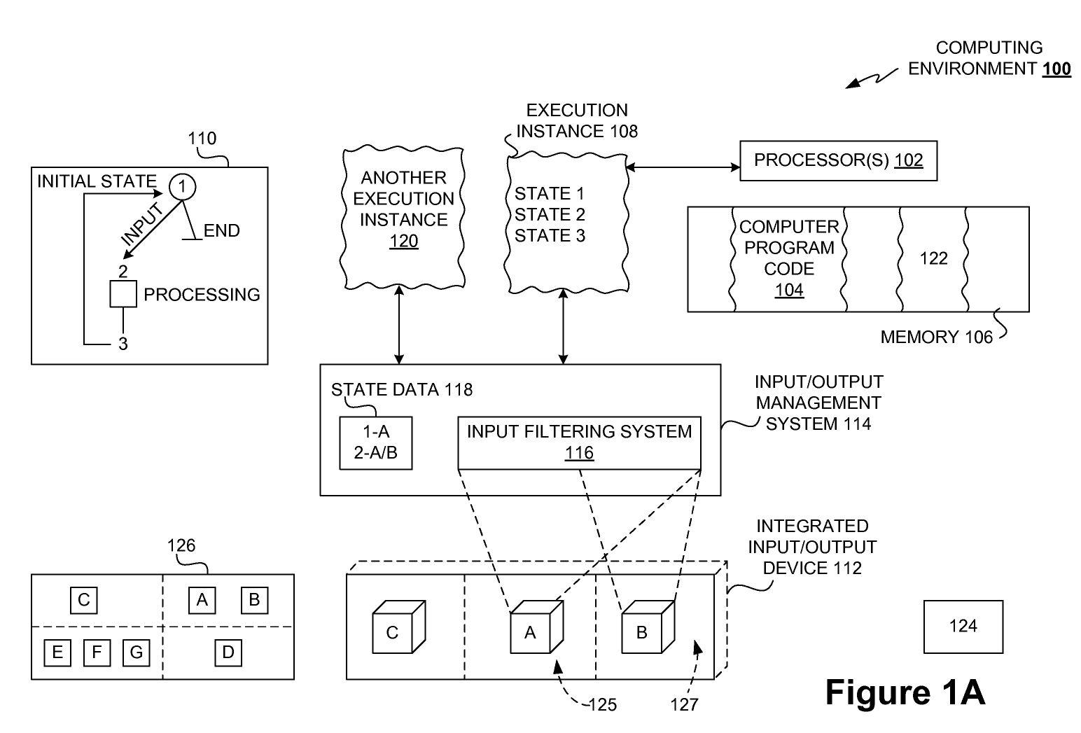

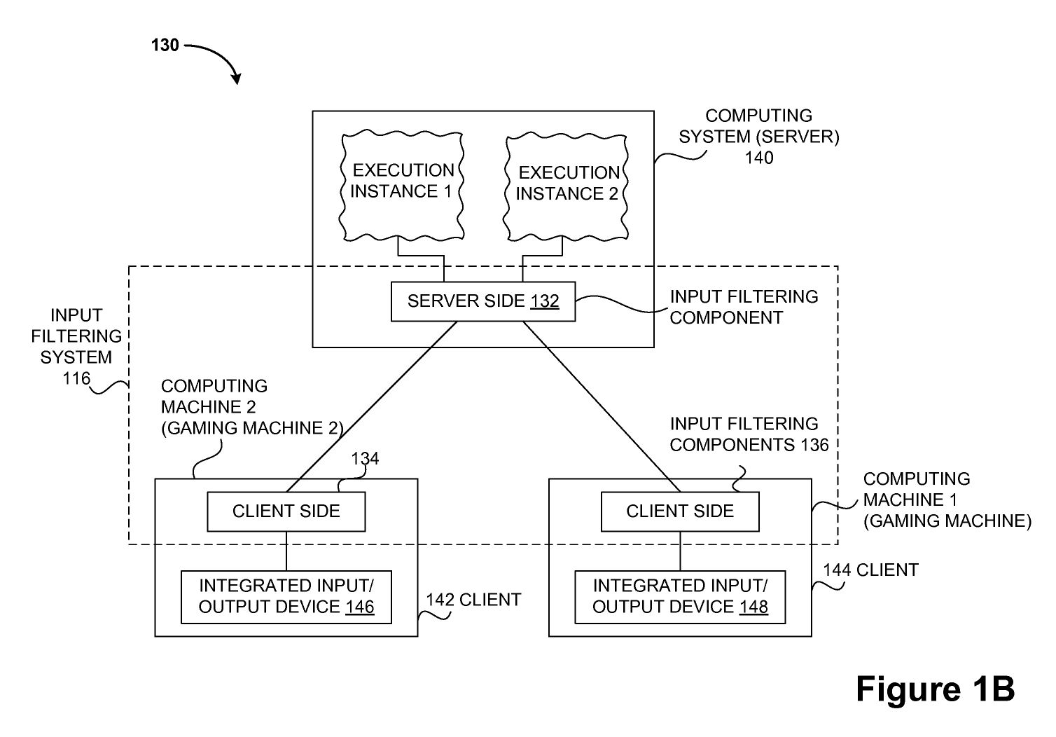

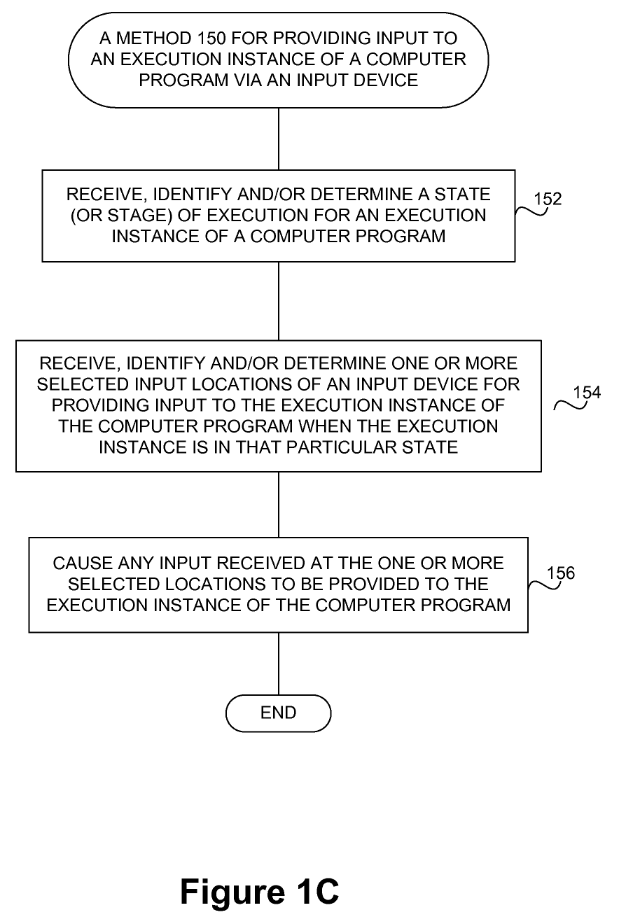

Embodiments of these aspects of the invention are discussed below with reference to FIGS. 1A-12. However, those skilled in the art will readily appreciate that the detailed description given herein with respect to these figures is for explanatory purposes as the invention extends beyond these limited embodiments.

FIG. 1A depicts a computing environment 100 in accordance with one embodiment of the invention. Referring to FIG. 1A, one or more processors 102 can effectively execute the computer program code 104 stored in the memory 106. Conceptually, an execution instance 108 of the computer program code 104 is executed by the one or more processors 102 in the computing environment 100. Those skilled in the art will appreciate that the execution instance 108 can be in various execution states during the execution time (or runtime) when the computer program code 104 is executed. Referring to FIG. 1A, the execution states are represented in an exemplary diagram 110 where the execution instance 108 can be initially in an initial state 1 (one). In the initial state (state 1), input can be received and result in switching the execution state to a second execution state (state 2) where the input is processed. Subsequently, a third execution state (state 3) is entered where output is generated based on the processing performed at the second execution state. Those skilled in the art will also appreciate that generally input and output can be provided to and received from the execution instance 108 of a computer program code 104 via input/output devices. For the sake of completeness, an input/device capable of providing both input and output will be discussed. For clarity, the input/device is also referred to as an “integrated” input/output device. However, it will be clear that described embodiments can be provided for an input device which need not necessarily be configured for providing output.

Referring back to FIG. 1A, an integrated input/output device 112 is configured to effectively provide both input and output in connection with the execution instance 108. However, it will be appreciated that instead of providing all input that is effectively entered into the integrated input/output device 112 directly to the execution instance 108, an input/output managing system 114 can effectively filter the input before providing it to the execution instance 108. More particularly, an input filtering system 116 can effectively focus on one or more discreet locations (e.g., positions, areas, points, surfaces) of the integrated input/output device 112 for input that can be provided to the execution instance 108. It will be appreciated that one or more discreet locations can be selected for receiving input when the execution instance is in a execution state. By way of example, when the execution instance 108 is in the first state of the execution, the input filtering system 116 can effectively focus on the selected discreet location A of the integrated input/output device 112 and effectively ignore the other remaining locations of the integrated input/output device 112 with respect to any input provided to the execution instance 108. As such, at each execution state, only input from one or more selected locations of the integrated input/output device 112 can be provided to the execution instance 108. The input filtering system 116 can use the state data 118 pertaining to the execution state of the execution instance 108. By way of example, the state data 118 can effectively indicate that the discreet location A of the integrated input/output device 112 is the only location for providing input to the execution instance 108 when the execution instance 108 is in the initial (or first) execution state shown in diagram 110. Similarly, when the execution instance 108 is in the second execution state, the state data 118 can effectively indicate that input to the execution instance 108 can only be provided at the discreet locations A and B of the integrated input/output device 112, and so on. It should be noted that multiple input can be provided when the integrated input/output device 112 is configured for receiving multiple input (e.g., when the integrated input/output device 112 is a device configured to receive multiple input, for example, a multi-touch screen. Multiple input can, for example, be effectively provided simultaneously, about the same time, or in an overlapping manner. Moreover, it will be appreciated that the input filtering system 116 can receive, identify and/or determine, based on a particular state of the execution of the execution instance 108, one or more discreet locations of the integrated input/output device 112 selected as one or more selected input locations for monitoring input, thereby effectively allowing all other non-selected locations to be ignored when the execution instance 108 is in a particular state of execution. By way of example, when the execution instance 108 is in the first or second state of execution, only input received at the selected locations A and B are provided to the execution instance 108. This means that input received at a non-selected location (e.g., location C) of the integrated input/output device 112 is effectively ignored. It will be appreciated that focusing on one or more selected input locations allows using more sophisticated and/or time consuming techniques for detecting input. Those skilled in the art will also appreciate that one or more other execution instances 120 can be effectively executed by the one or more processors 102 at the same time as the execution instance 108 and/or at a different time. Computer program code 122 for the one or more other execution instances 120 can, for example, be stored in the memory 106 and/or another storage (not shown). In any case, the input filtering system 116 would be able to effectively select one or more discreet locations of the integrated input/output device 112 for the computer program code 104 and/or another one or more execution instances 120 which can, for example, be executed concurrently. It should be noted that one or more other integrated input/output devices 124 can also be configured for receiving input and generating output for the execution instance 108 and/or other integrated input/output devices 112. Moreover, it will be appreciated that the input filtering system 116 and/or another one or more input filtering systems 117 can effectively filter input for the integrated input/output devices 124. Further, it will be appreciated that each of the integrated input/output device 112 and/or the other devices 124 can be effectively divided into portions whereby each portion is designated for providing input and output to a particular execution instance of multiple execution instances that can, for example, be executed concurrently. By way of example, the integrated input/output device 112 can be divided into portions 125 and 127 for providing input and output respectively for the execution instance 108 and one of the execution instances 120.

Referring to FIG. 1B, an integrated input/output device 126 is depicted as being effectively divided into four portions corresponding to four execution instances of the same and/or different computer program code. At each state of the execution for a particular execution instance, one or more selected input locations of a designated portion can be determined by the input filtering system 116. Those skilled in the art will readily appreciate that the input filtering system 116 of the input/output management system 114 can, for example, be provided in a computing system that includes the one or more processors 102 and memory 106. Alternatively, the input filtering system 116 can be effectively provided as an independent computing system with its own processors and memory. As such, the input filtering system 116 can be provided for execution of computer program code 104 on an individual computing system or it can be provided for a computing system (e.g., a gaming server) that effectively serves one or more other computing systems (e.g., gaming machines).

Generally, the input filtering operations of the input filtering system 116 can be effectively divided between a number of different entities operating respectively on different computing systems.

To further elaborate, FIG. 1B depicts an input filtering system 116 effectively distributed in a computing environment 130 in accordance with one embodiment of the invention. Referring to FIG. 1B, the input filtering system 116 (also shown in FIG. 1A) includes serve-side component 132 and client-side components 134 and 136. The server-side input filtering component 132 can be provided for the computing system 140 to accommodate the capabilities of the server with respect to services it provides to its clients, namely that effectively behaves as a server to the computing systems 142 and 144. By way of example, the computing system (or server) 140 can effectively manage the execution of execution instances 1 and 2 for computing systems (or clients) 142 and 144. Moreover, the server-side input filtering component 132 can effectively determine, select and/or identify one or more selected input locations of the integrated input/output devices 146 and 148 where input can be provided for the respective execution instance. Those skilled in the art will appreciate that the selected input locations can, for example, be provided as virtual locations which are effectively mapped by the client-side input filtering components 134 and 136 to the physical (or actual) input locations on the input/output devices 146 and 148. The client-side input filtering components 134 and 136 can also effectively focus on the selected physical input locations of their respective input/output devices 142 and 144 in order to detect any input that may be provided. Input detected at a selected physical location can be communicated by the client-sides (134 and 136) to the server-side input filtering component 132. In order to determine, identify and/or select a virtual input location, execution state of each of the execution instances 1 and 2 can be considered. More particularly, the server-side input filtering component 132 can effectively determine, receive and/or identify various execution states of the execution instances 1 and 2 and provide any input effectively identified by the client-side to the respective execution instances 1 or 2. The state of execution of execution instances 1 and 2, among other things, can change based on the input provided to the execution instances. Those skilled in the art will readily appreciate that some or all of the operations of the client-sides 134 and 136 may also be effectively performed by the server-side 102. As such the client-side input filtering components 134 and 136 could effectively merge with the server-side input filtering system 132 and be performed under the control of the computing system (or server) 140. As such, the computing system (or server) 140 can be configured to directly communicate with the integrated input/output devices 146 and 148.

FIG. 1C depicts a method 150 for providing input to an execution instance of a computer program via an input device in accordance with one embodiment of the invention. The input device can, for example, be an input/output device (or integrated input/output device) such as touch-screen or multi-touch screen.

Initially, a state of execution of a computer program (an instance of execution of a computer program) is received, identified and/or determined (152). Next, one or more selected input locations of the input device are received, identified and/or determined (154). Typically, the one or more selected locations are determined based on the state of the execution of the computer program. The one or more selected input locations can be discreet locations of the input device selected for providing input to a particular execution instance of the computer program when the execution instance is in a particular state. After receiving, identifying and/or determining (154) one or more selected input, any input received at the one or more selected input locations is caused (156) to be provided to the execution instance of the computer program. Typically, input is provided to the execution instance of the computer program while still in the same execution state. However, the execution state can be changed as a result of the input. The method 150 ends after any input received at the one or more selected input locations are caused to be provided to the execution instance.

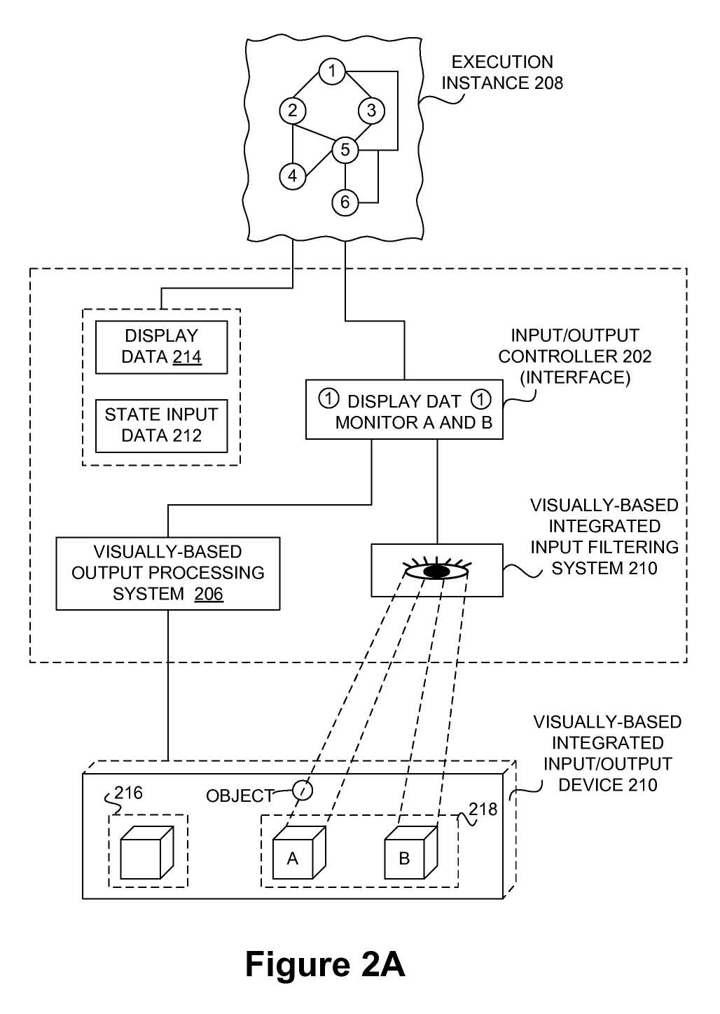

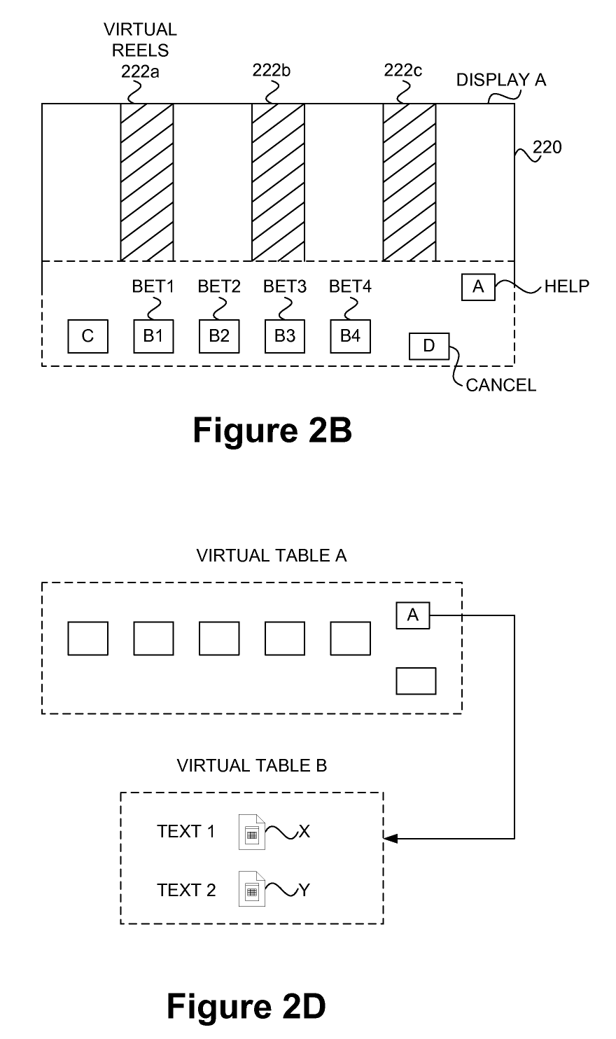

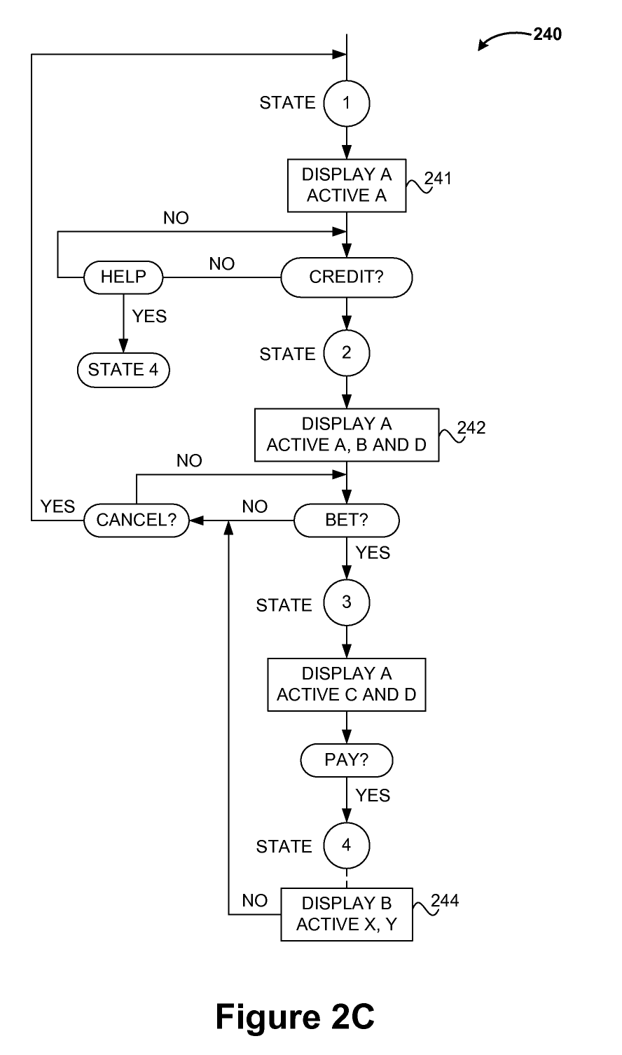

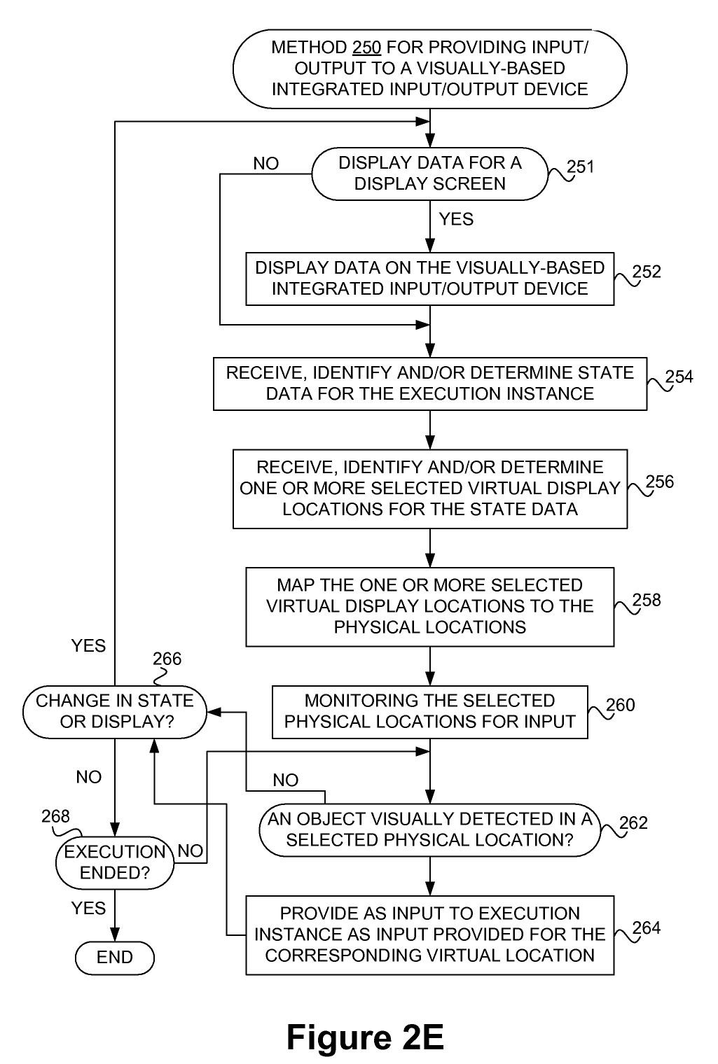

It will be appreciated that the integrated input device 112 (depicted in FIG. 1A) can, for example, be and/or include a visually based integrated input/output device (e.g., touch screen, multi-touch screen). To further elaborate, FIG. 2A depicts a visually-based input/output management system 200 in accordance with one embodiment of the invention. Referring to FIG. 2A, an input/output controller (or interface) 202 effectively manages, controls and/or interfaces with a visually-based output processing system 206 and a visually-based input filtering system 204. In effect, the input/output controller 202 interfaces with an execution instance 208 and manages input/output operations for it with respect to visually-based integrated input/output device 210. As suggested by FIG. 2A, the execution instance 208 can be in various execution states at a given time. The state input data 212 can effectively represent the state of the execution for the execution instance 208. The state input data 212 can, for example, be provided by the execution instance 208 and/or determined by the input/output controller 202 based on information pertaining to execution of the execution instance 208. In a similar manner, the display data 214 corresponding to output for the visually-based input/output device 210 can also be output to the visually based output system 206. It will be appreciated that the visually-based input/output management system 200, input and output operations can be coordinated for the visually-based input/output device 210. By way of example, when the execution instance 208 is in a particular execution state (e.g., execution state 5), display data 214 can effectively indicate to display data in the locations (e.g., portions, regions) 216 and 218 of the visually-base integrated input/output device 210. Further, the state input data 212 can effectively identify the selected input locations A and B within the displayed location 218 for receiving input when the execution instance 208 is in that particular execution state (e.g., execution state 5). As a result, the visually-based integrated input filtering system 204 can effectively focus only on the selected input locations A and B within the displayed region 218 for providing input to the execution instance 208 when the execution instance 208 is in that particular execution state. This means that the other locations of the visually-based integrated input/output device 210 including the display portion 216 can be effectively ignored by the visually based input filtering system 204 when the execution instance 208 is in a given state of execution.

The visually based integrated input/output device 210 (shown in FIG. 2A) can, for example, be and/or include a multi-touch screen capable of receiving multiple inputs (e.g., input received when multiple objects touch the touch-screen at multiple locations).

To further elaborate, FIG. 2B depicts a multi-touch screen (or screen) 220 in accordance with one embodiment of the invention. The multi-screen depicted in FIG. 2B represents a game screen that can be provided for a particular game, for example, on a gaming machine operating in a gaming environment. Referring to FIG. 2B, three virtual reels 222 are depicted for a virtual reel-based game. The bottom portion of the multi-touch screen 220 depicts various input areas provided for receiving input used to effectively play the virtual reel-based game. The display screen 220 can, for example, be an initially display (display A) displayed at the initial stage (or beginning) of the reel-based game. In this initial state, only one input area A can be effectively activated for receiving input. In other words, the remaining portions of the multi-touch screen 220 including the various other input portions A, B and C are effectively ignored with respect to any input that may be entered while the virtual reel-based game is in the initial stage. During the course of the game, the display of information and/or the selected (or activated) input locations of the touch-screen 220 can change. Generally, the course of execution including various states of execution can be stored at data storage. By way of example, a state diagram or state machine representative can be provided to effectively define and/or indicate data to be displayed as well as the locations to select (or activate) for receiving input at different states (or stages) of the execution of the computer program code for the virtual reel-based game what information to display and what input locations to be activated for receiving input.

To further elaborate, FIG. 2C depicts a simplified state diagram or state machine 240 in accordance with one embodiment of the invention. Referring to FIG. 2C, at an initial state (state 1), state input/output data 241 indicates that display screen A (shown in FIG. 2B) is to be displayed and only its input area A is activated for receiving input. Referring back to FIG. 2B, the active input location A can, for example, correspond to a designate “help” selection may be available when the reel-based game has initiated but no credit (payment or wager) has been received yet. Referring now to FIG. 2C, when credit is effectively provided, execution of the virtual reel-based game can move (or switch) from the first state (state 1) to a second state (state 2). Referring back to FIG. 2B, the state input/output data 212 provided for state 2 can indicate that input areas A, B (B1-B4) and D are active for the same display A. Again, it should be noted that the input locations not identified by the state input data 242 are effectively ignored with respect to any input that was provided. Referring back to FIG. 2C, depending on the input received from the selected input locations A, B and D, the state of execution can move (or switch), for example, back to the state 1 or forward to the state 3, and so on. Referring again to FIG. 2B, at state 4 when actual game play is initiated, one or more different display screens B can be displayed as indicated by the input/output state data 242 associated with the state 4 (e.g., the virtual reels 222 are depicted in FIG. 2B).

In general, display data (e.g., screens) and/or the locations of various selected locations for receiving input at different states (or stages of execution) can be stored as data. The data can, for example, be provided as virtual tables. Referring to FIG. 2D, simplified virtual tables for the virtual reel-based game are depicted in accordance with one embodiment of the invention. The virtual table A can, for example, represent the display screen 220 (or display A) shown in FIG. 2B. Initially, the virtual table A can effectively identify the selected input locations and be associated with a particular state of execution, state 1 of the input area A, can be identified as the selected input area for receiving input. Similarly, a virtual table H represents the display that can be displayed if the selected input location A (shown in FIG. 2B) associated with a “help” function is selected. Referring to FIG. 2D, virtual table H can be associated with or referenced by the virtual table A. The virtual table H can, for example, effectively provide and/or reference display data (text 1 and text 2) and further identify one or more input locations (X and Y) that have been selected for receiving input, namely, selection input areas or locations X and Y.

FIG. 2E depicts a method 250 for providing input/output to a visually-based integrated input/output device in accordance with one embodiment of the invention. Initially, it is determined (251) whether to display data on the integrated input/output device. Accordingly, data (or display data) can be displayed (252) on the visually-based integrated input/output device if it is determined (251) to display data. The display data represents data to be displayed when an execution instance of a computer program is initiated (e.g., computer program code for a game is initiated and initial display screen(s) is/are displayed. Subsequently, state data for the execution instance of a computer program is received, identified and/or determined (254). Next, one or more selected virtual display locations are received, identified and/or determined (256) for receiving input when the execution instance is in the execution instance. It will be appreciated that the one or more selected virtual display locations are determined and/or correspond to the state data of the execution instance. Subsequently, the one or more selected virtual display locations are effectively mapped (258) to one or more corresponding physical locations of the visually-based integrated input/output device. Thereafter, the one or more selected physical locations of the visually based integrated input/output device are monitored (260) for input. Accordingly, it is determined (262), based on the monitoring (260) whether an object is visually detected in a selected physical location of the visually-based integrated input/output device. As such, if it is determined (262), based on the monitoring (260), that the physical object is visually detected in the selected physical location, input is provided to the execution instance in connection with the corresponding virtual locations, thereby allowing the execution instance to process the input. It should be noted that if it is determined (262) that an object is not visually detected in a selected physical location, it is determined (266) whether there is a change in the state of execution or the information to be displayed (display data). As such, display data can be effectively displayed (252) to update a display screen and/or updated state data can be received, determined and/or identified (254) in a same manner as discussed above. In effect, the method 250 can wait to detect (262) an object in an selected physical location until a change in the state or display information is detected (266) or it is determined (268) to end the execution of the computer program (268). The method 250 ends when it is determined (268) to end the execution of the execution instance.

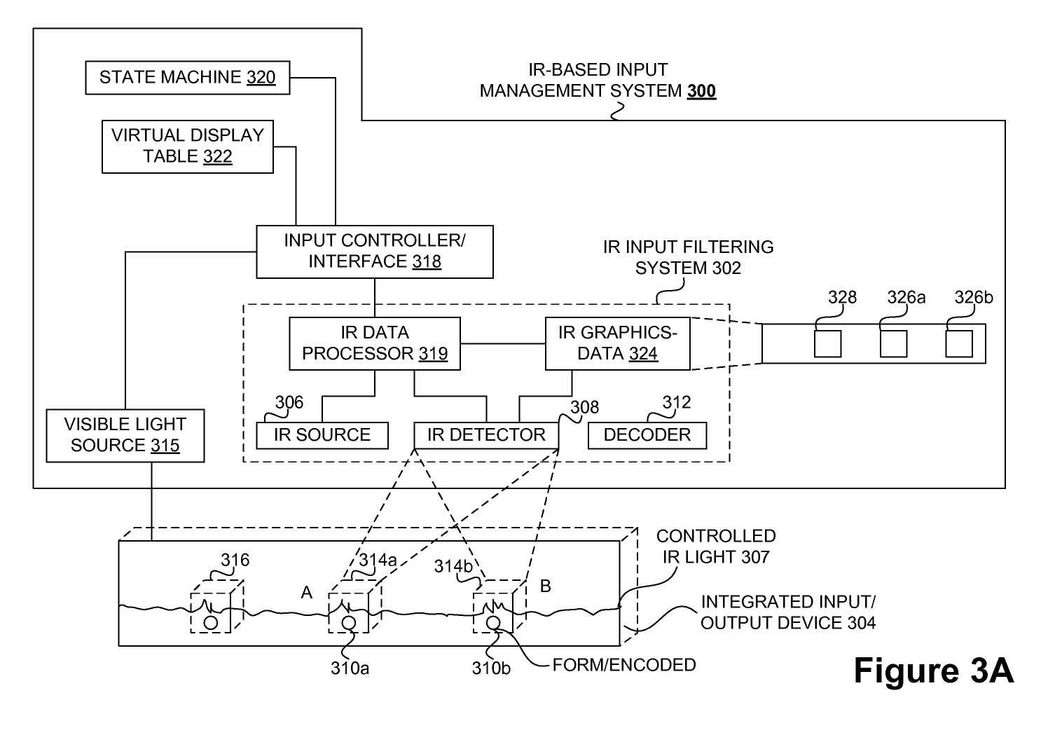

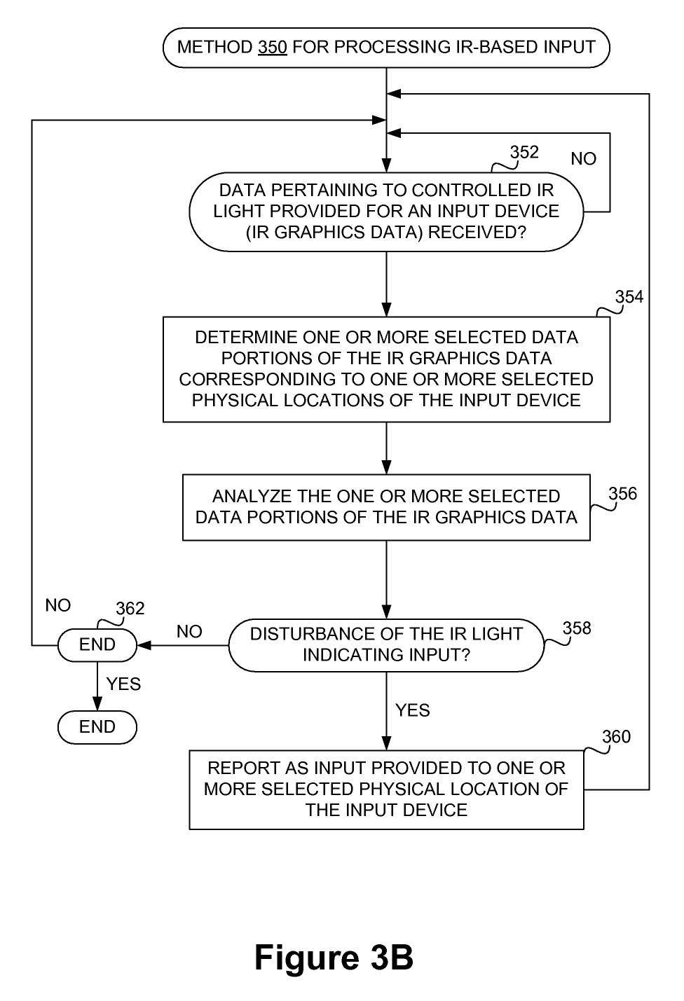

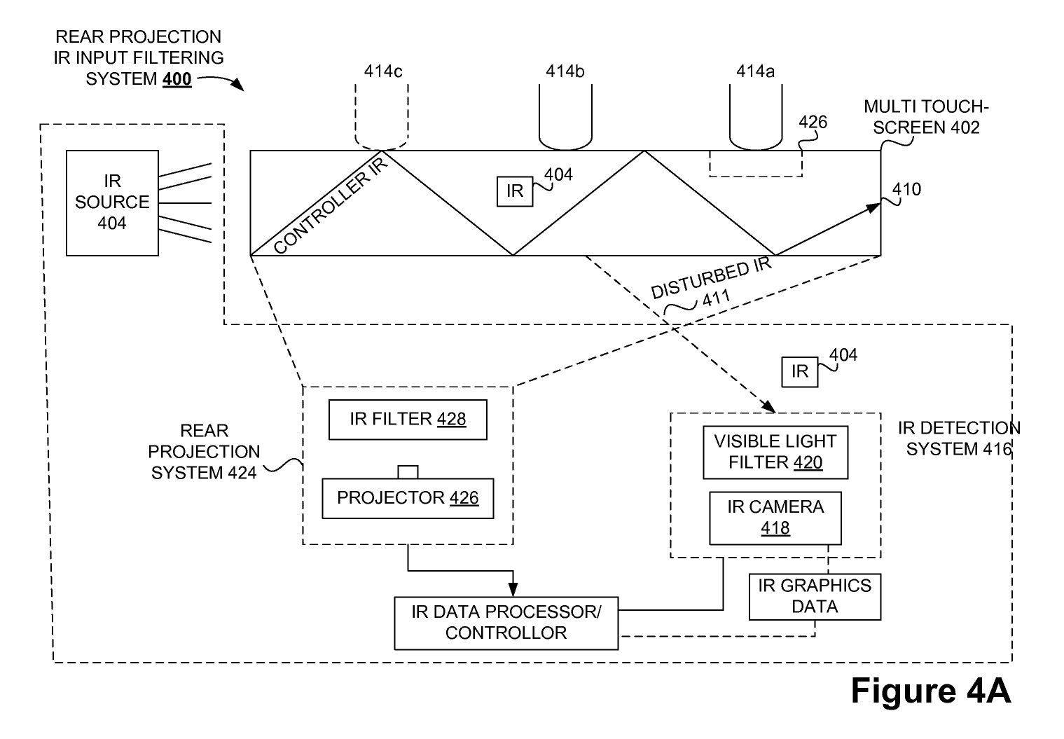

It should be noted that the visually-based integrated input/output management system 200 (shown in FIG. 2A) can, for example, be and/or include an Infrared Light (IR-based) input management system. To further elaborate, FIG. 3A depicts an IR-based input management system 300 in accordance with one embodiment of the invention. Referring to FIG. 3A, an IR input filtering system 302 is effectively provided to filter the input received by the integrated input/output device 304. It should be noted that the integrated input/output device 304 is a visually-based device (e.g., a touch screen) when information can be displayed and input can be entered by making contact with the device. Moreover, the IR input filtering system 302 can visually detect the presence of objects that contact (e.g., touch) an input surface of the integrated input/output device 304 to monitor the integrated input/output device 304, an IR source (306) provided by the IR input filtering system 302 can effectively emit a controlled IR light for the integrated input/output device 304. It will be appreciated that the controlled IR light (307) can be provided in a manner that allows detecting the presence of a physical object 310 by an IR detector (308). More particularly, the presence of an object 310 when it comes in effective contact with an input surface can disturb the controlled IR light 307 in a manner that the disturbance is detected by the IR detector 308. In other words, the IR detector 324 can visually detect that input has been provided in one or more locations 314 of the integrated input/output device 304. The locations 314 can correspond to selected input locations for providing input to a computer program as discussed above. Although input can be detected at any location of the integrated input/output device 304, it will be appreciated that the IR filtering system 302 can effectively focus on one or more selected input locations (e.g., 314) to determine whether input has been received. This means that other locations of the integrated input/output device 304 including a non-selected location 316 need not be monitored and input provided to the non-selected location 316 can be effectively ignored (e.g., input provided to the non-selected location 316 is not provided to the computer program being executed as input).

It will be appreciated that the physical object 310 can have a particular form and/or be encoded. Moreover, the IR input filtering system 302 can be configured to detect various forms and/or sizes of objects and encodings.

By way of example, the input filtering system 302 can be configured to detect the presence of forms for physical objects that are likely to be a human finger or other approved devices for entering input (e.g., stylus, pens). As another example, an object 310b can, for example, be an encoded object of a particular size and/or shape (e.g., casino ship or identification card with a particular size and shape) that is encoded with gaming information, when an encoded object is detected, decoding mechanisms can be employed to decode the data encoded in the object. Referring to FIG. 3A, an optional decoder 312, for example, can decode the encoding of an encoded object provided as an object.

It should be noted that output can be displayed on the integrated input/output device 304 by a visible light source 315 (e.g., a projector) on the integrated input/output device 304. The displayed output can correspond to or be coordinated with, for example, the selected input locations 314, a non-selected input location 316 at a given time. It should also be noted that the IR input filtering system 302 may also be configured to interface with an input controller (or interface) 318 that can effectively communicate with an instance of a computer program during execution time. As such, the input controller 318 can be configured to access state machine 320 and/or virtual display tables 322 pertaining to the execution instance. This provides access to the display information and/or allows identifying the selected input locations at any particular state (or stage) of the execution of a computer program.

It should be noted that the input controller 318 can, for example, be provided as a different computing system (e.g., a server) than that the computing system (e.g., client) that effectively provides the IR input filtering system 302. As another example, the IR input filtering system 302 may be configured to access the state machine 320 and/or virtual display tables 322 directly and/or without the present of the input controller 318.

In any case, when one or more selected input locations 314 are determined for monitoring input, an IR data processor 319 can effectively process the IR graphics data effectively representing a visual picture of the input surfaces (or areas) of the integrated input/output device 304. More particularly, the IR detector 308 can provide IR graphics data 324 for processing by the IR data processor 319. The IR graphics data 324 can, for example, correspond to a visual picture of the entire integrated input/output device 304. However, it will be appreciated that the IR data processor 319 can effectively focus on the data portions representing the one or more selected input locations 314. Referring to FIG. 3A, IR graphics data 324 is depicted to include data portions 326a and 326b respectively corresponding to the selected input locations 314a and 314b. It will be appreciated that the IR data processor 319 can process only the data portions 326a and 326b corresponding to the selected input locations 314a and 314b. This means that the IR data processor 319 can effectively ignore all other data including the data portion 328 corresponding to the non-selected input location 316.

FIG. 3B depicts a method 350 for processing IR-based input in accordance with one embodiment of the invention. The method 350 can, for example, be performed by the IR input filtering system 302 depicted in FIG. 3A to filter input received by a visually-based integrated device. Initially, it is determined (352) whether data pertaining to controlled IR light emitted on a visually-based input device is received. It will be appreciated that data pertaining to the controlled IR light (IR graphics data) can, for example, be provided by a IR detector (e.g., a camera) configured to detect IR light. If it is determined (352) that IR graphics data is received, one or more selected data portions of the IR graphics data are determined (354). It should be noted that one or more selected data portions of the IR graphics data correspond to one or more selected physical locations of the input area of the input device. The one or more selected physical locations of the input device can, for example, correspond to one or more virtual input locations provided for receiving input in connection with execution of a computer program.

Next, the one or more selected data portions of the IR graphics data are analyzed to detect presence of input (356). Based on analysis (356) of the one or more selected data portions, it is determined whether a disturbance of the IR light which indicates input is detected (358). If no input is detected (358), the method 350 can effectively wait to receive additional data pertaining to the controller IR light. In effect, IR graphics data can be received (352) and/or analyzed (356) periodically as needed. If a disturbance of the IR light indicating presence of input (358) is detected, input is reported (360). Input can be reported as input provided in connection with one or more selected physical locations of the input device. The physical locations can be effectively mapped to virtual input locations of an execution instance and be reported as input to the program (e.g., input can be reported as selecting of a play option) corresponding to input locations of the computer program. The method 350 ends when it is determined (362) to end processing the input. By way of example, the method 350 can end when the computer program terminates and there is no need for processing input.

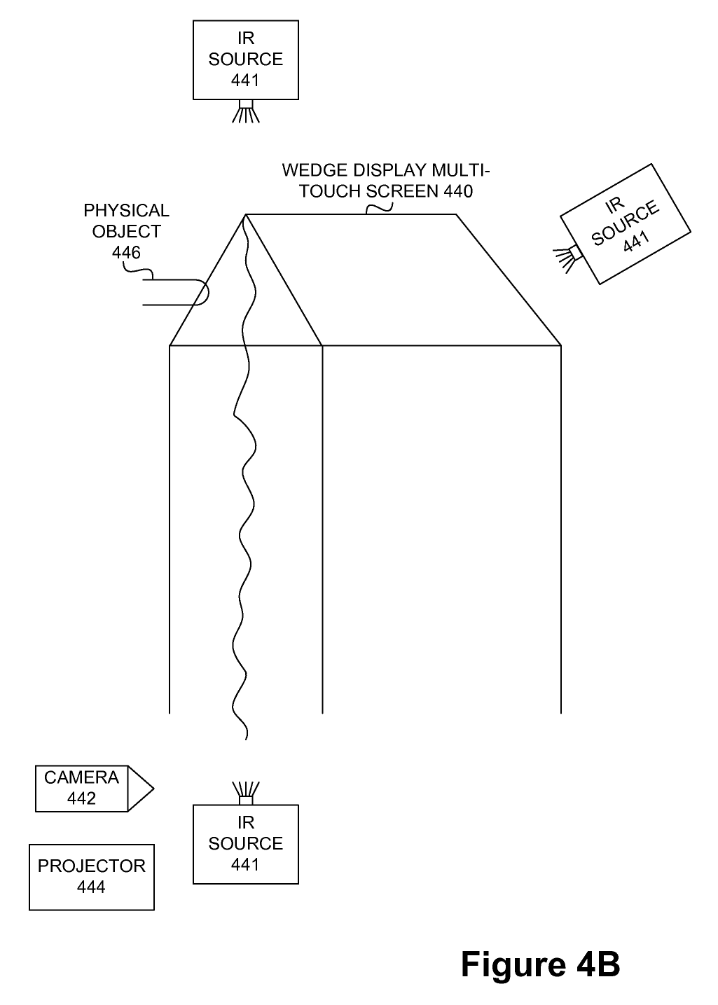

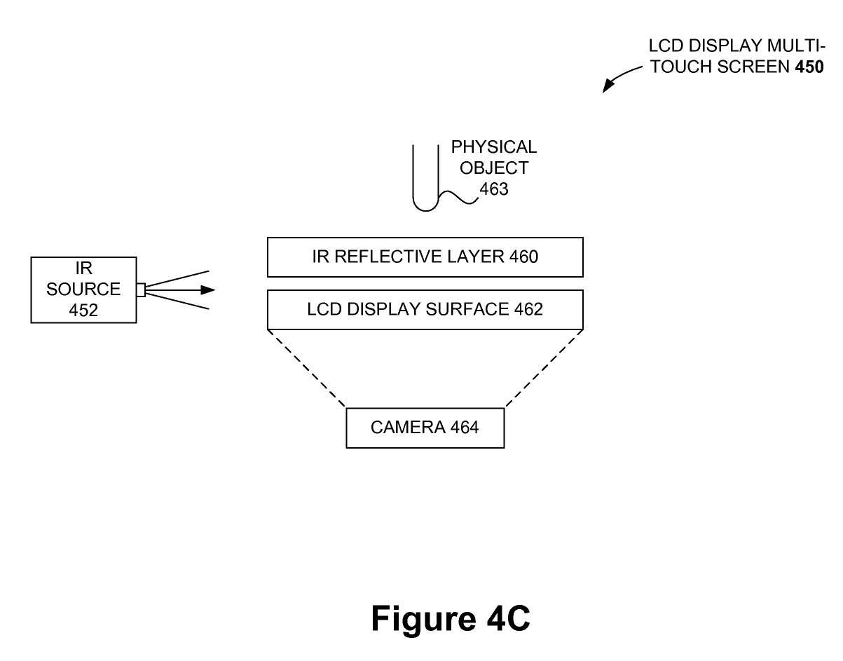

FIG. 4A depicts a rear projection IR input filtering system 400 provided for a multi touch screen 402 in accordance with one embodiment of the invention. Referring to FIG. 4A, an IR source 404 can be utilized to emit controlled IR light 410 for the multi-touch screen 402. The IR source 404 can, for example, emit the controlled IR light at a particular frequency or range frequencies for the multi-touch screen 402. As suggested by FIG. 4A, one or more IR sources 404 can be placed at various positions to effectively emit the IR light. These skilled in the art will appreciate that the one or more IR sources 404 can be placed at various positions including the side, front and rear of the multi-touch screen 402. The controlled IR light 410 can, for example, enter an edge of the multi-touch screen 402 and be reflected by substantially parallel edges of the surface of the multi-touch screen 402 in a phenomenon known as “internal reflection” or “total internal reflection”. Those skilled in the art will readily appreciate that the surface of the multi-touch screen 402 can be made of an appropriate rear projection material (e.g., glass).

Moreover, it will be appreciated that the IR light can be emitted in a manner that effectively puts it in or inside the multi-touch screen 402 in accordance with one embodiment of the invention. In other words, IR light can be effectively trapped inside a multi-touch screen in accordance with one embodiment of the invention. By way of example, IR light can be emitted from the side in a controlled manner that effectively puts it inside a glass element of the multi-touch screen 402 which is also used as a rear-projection surface for displaying images. As such, disturbance of the IR light 410 caused by anyone of the objects 414 can cause the IR light to divert out of the surfaces of the glass and be detected by the IR detecting system 416.

Referring to FIG. 4A, the IR detecting system 416 can include a camera component 418 and a visible-light filter 420. The visible-light filter 420 can effectively block the visible light and allow the camera component 418, the disturbed IR light 411 capture the IR light 410 as a result of a disturbance of the IR light 410 caused by an object 414. By way of example, when an object 414b comes in contact with the multi-touch screen 402, the controlled IR light 410 is disturbed so as to cause it to divert out of the surfaces of the multi-touch screen 402 as the disturbed light which is captured by the IR camera component 418. Generally, the IR camera 418 can be configured to capture any disturbance in the IR controlled light 410 (or disturbed IR light) caused by the presence of an object in close proximity and/or in contact with the multi-touch screen 402. The IR camera 418 can effectively provide in IR-based images IR graphics data. The IR graphics data 420 can effectively capture the properties of the distributed IR light 411 with respect with one or more locations of the touch-screen corresponding to the object 414 provided to an IR data processor and/or controller 422 and analyzed in a similar manner as discussed above. Again, it should be appreciated that the IR data processor and/or controller 422 can effectively focus on one or more selected portions of the IR graphics data 420 that correspond to selected input locations of the multi-touch screen 402. By way of example, a data portion of the IR graphics data 420 corresponding to pixels reflecting the physical location 426 which has been selected for receiving input can be examined while other data portions and their respective pixels are effectively ignored. As a result, although multi-touch screen 402 can receive multiple touches in a simultaneous and/or overlapping manner, multiple inputs can be effectively filtered by evaluating the data portions(s) for one or more selected input locations. By way of example, although multiple input can be provided at three discreet locations by three objects 414a, 414b and 414c, only physical objects 414a and 414b which correspond to selected input locations of the multi-touch screen 402 can be effectively recognized as input as the only data portions of the IR graphics data that represented the selected input locations are processed to effectively monitor the selected input locations for input provided by an object. It will be appreciated that the rear-projection IR input filtering system 400 allows use of more complicated detection mechanisms for the selected input locations. By way of example, the shape and/or size of the object 414a can be examined to detect an object approved for providing input. In addition, encoded objects can be detected and decoded. It should be noted that data could be displayed using a rear-projection system 424 which projects images on the multi-touch screen 402. The projection of images which can be coordinated with the IR detection system 416 to detect input provided in connection with the displayed images. Referring to FIG. 4A, the rear projection system 424 includes the projector component 426 and an IR filter 428. The IR filter 428 can effectively block the IR light emitted by the projector 426. Those skilled in the art will appreciate that the IR filter 428 can be integrated with the projector 426 and/or be provided as a separate component as shown in FIG. 4A. IR and/or visible light filters can, for example, made out of glass with an appropriate level of encoding or plastic with different layers. The controlled IR light 410 emitted at a particular frequency or a range of frequencies can be detected by the IR camera 418 configured to capture IR light at that particular frequency or a range of frequencies.

Those skilled in the art will also appreciate that various forms of displays and technologies can be used to provide a multi-touch screen configured for an input filtering system provided in accordance with one embodiment of the invention. One such example is a wedge display multi-touch screen which will be discussed next.

Referring to FIG. 4B, a wedge display multi-touch screen 440 is depicted in accordance with one embodiment of the invention. It should be noted that the IR source 441 can be provided at various positions with respect to the wedge display 440. In addition, the camera 442 and projector 444 can be provided with integrated or separate filters in a similar manner as discussed above. To better display that multi-touch screen 440 can effectively behave as a two-way screen where output is displayed and physical object 446 can effectively touch the screen and be detected as output.

As an example, FIG. 4C depicts an LCD display multi-touch screen 450 in accordance with one embodiment of the invention. Referring to FIG. 4C, an IR reflective layer or coding 460 is provided for the LCD display surface 462. An IR source 452 can emit IR light from a side position and be reflected by the IR reflective layer 460 onto the LCD display surface 462. The IR reflective layer 460 may, for example, be made of the perforated reflective material that allows the IR light to pass to the surfaces of the LCD display 462. A physical object 463 can disturb the IR light. The disturbed IR light is captured by a camera 464. The camera 464 can effectively detect the IR light via a visible light filter.

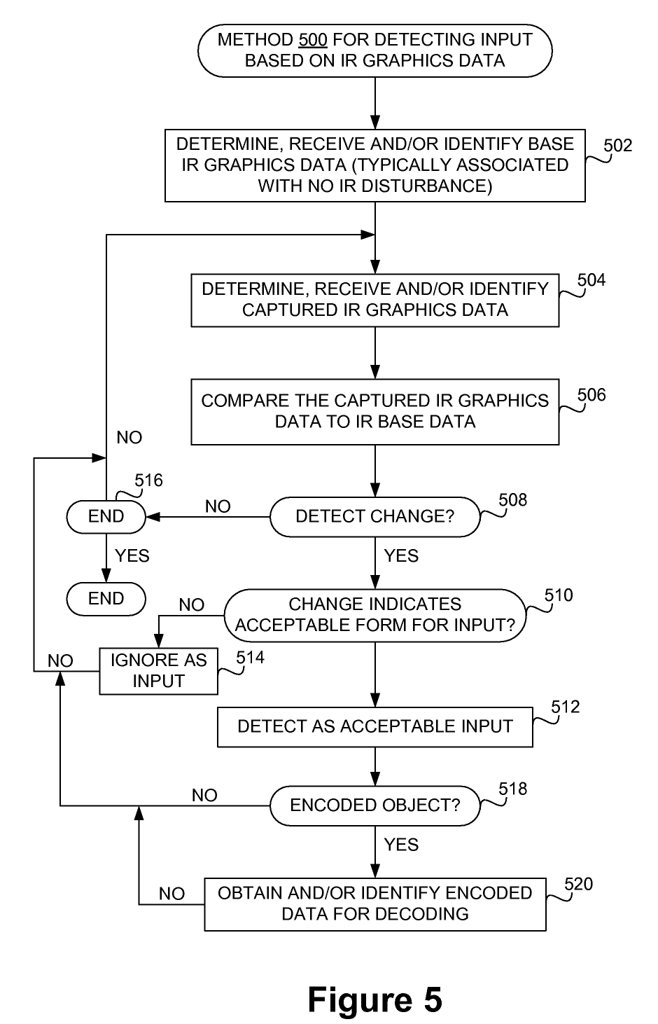

As noted above, a physical object that disturbs the controlled IR light can be detected as input. The input can be detected based on IR graphics data captured by a camera. To further elaborate, FIG. 5 depicts a method 500 for detecting input based on IR graphics data. The IR graphics data can, for example, be captured by the IR detection system 416 shown in FIG. 4A. As such, the method 500 can, for example, be performed by the IR data processor/controller 422 shown in FIG. 4A.

Referring to FIG. 5, initially, base IR graphics data is determined, received and/or identified (502). Typically, the base IR graphics data represents a state where controlled IR light is not disturbed (i.e., state where no input is provided). Next, captured IR graphics data is determined, received and/or identified. Subsequently, the captured IR graphics data is compared to the IR base data 506). Accordingly, it is determined whether there is a significant different between the IR base data and the IR graphics data. By way of example, it can be determined (506) whether the change in contrast ratio exceeds a determined threshold and/or there is particular change in contrast ratio. If it is determined (508) that there is a significant change, it is determined (510) whether the change represents and/or indicates an acceptable form of inputs. By way of example, several forms of physical objects including fingers, stylus can be considered to be acceptable for providing input to a multi-touch screen configured for a gaming machine. An acceptable form of object can be detected (512) accordingly. On the other hand, if it is determined (510) that the change detected does not represent an acceptable form of input, input is effectively ignored (514). If it is determined (508) that no change between the base data and the captured data is detected, the method 500 can proceed to determine, receive and/or identify (504) captured IR data in a similar manner as discussed above. In effect, the method 500 can receive captured IR data and determine whether any change to the base data is detected (508) until it is determined (516) to end detecting input (or effectively monitor for input). The method 500 can, for example, end as a result of the termination of a computer program configured to receive input. On the other hand, after detecting acceptable input (512), it is determined whether an encoded object is detected (518). If it is determined (518) that an encoded object is detected, the encoding data of the encoded object is obtained and/or identified (524) for decoding. The method 500 can proceed in similar manner as noted above to determine, receive and/or identify captured IR graphics data (504) until it is determined (516) to end detecting input.

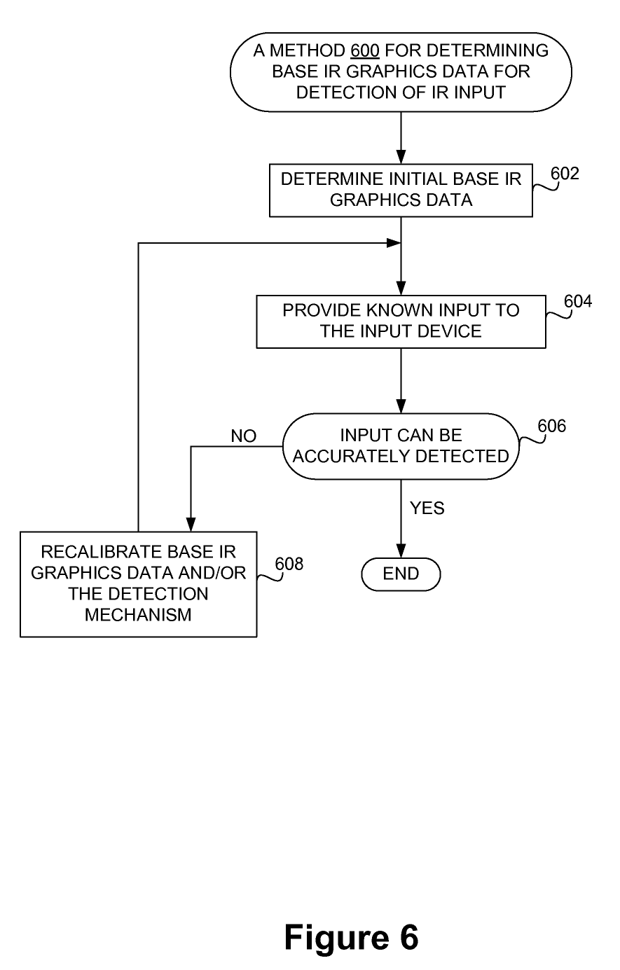

It will be appreciated that the base IR graphics data can be effectively adjusted in order to taking into account various factors including any physical changes to an input device. These physical changes can, for example, include wear and tear of the glass material provided for a multi-touch screen. To further elaborate, FIG. 6 depicts an exemplary method 600 for determining base IR graphics data for detection of IR input in accordance with one embodiment of the invention. Referring to FIG. 6, initial base IR graphics data is determined (602). The IR graphics data can, for example, represent a visual picture of the input device where controlled IR light is undisturbed (i.e. no input is provided to the input device). Next, input is provided to the input device (604). The input is provided in a determined and/or known manner. By way of example, a physical object of known size, shape and/or form can be provided in a particular location of the input device. Subsequently, it is determined (606) whether the input can be accurately detected. If it can, for example, be determined whether the dimensions, size and/or form of the known input can be accurately detected using the current detection mechanism. If it is determined (606) that the input provided can be accurately detected, the method 600 ends. However, if it is determined that a known input cannot be detected accurately, the IR base graphics data and/or detecting mechanisms are recalibrated (608). Those skilled in the art will appreciate that the recalibration (606) can include human intervention to, for example, detect any malfunctioning and deficiencies in the physical input device and/or modifying the detection parameters used by the detection mechanisms. It is also possible to perform the recalibration (608) in an automated manner where few detection parameters are measured in order to effectively predict a known problem. By way of example, if input cannot be detected in a particular physical location of the input device, further analysis can effectively indicate that the particular physical location of the input device is malfunctioning. As a result, the base IR graphics data corresponding to the malfunctioning physical location of the input device can be adjusted and/or other detection mechanisms may be used to detect input for that particular physical location.

A functioning physical location can be used to replace the malfunctioning physical location. As such, a selected input location can be effectively mapped to a different physical location when a malfunction is in a physical location originally assigned is detected. In any case, after recalibration (608) input can be provided (604) and it can be determined (606) whether the input can be detected in a similar manner as discussed above.

Those skilled in the art will appreciate that the known input can be provided (604) at one or more selected input locations and the entire surface of the input device can be tested. Further, multiple inputs can be provided to test the ability to detect multiple input provided, for example, at the same time or in an overlapping manner. The method 600 can, for example, be performed as a background operation (or process) during the runtime.

It will be appreciated that numerous computing environment can benefit from the techniques described above. In general any computing environment where input is processed would benefit. In particular, computing environments where accurate detection of input is highly desirable and/or multiple touches can be provided would benefit from the techniques discussed above. One such example is gaming environment where multiple objects of various forms can be provided knowingly or unknowingly to a multi-touch screen by a player of a gaming machine (or device).

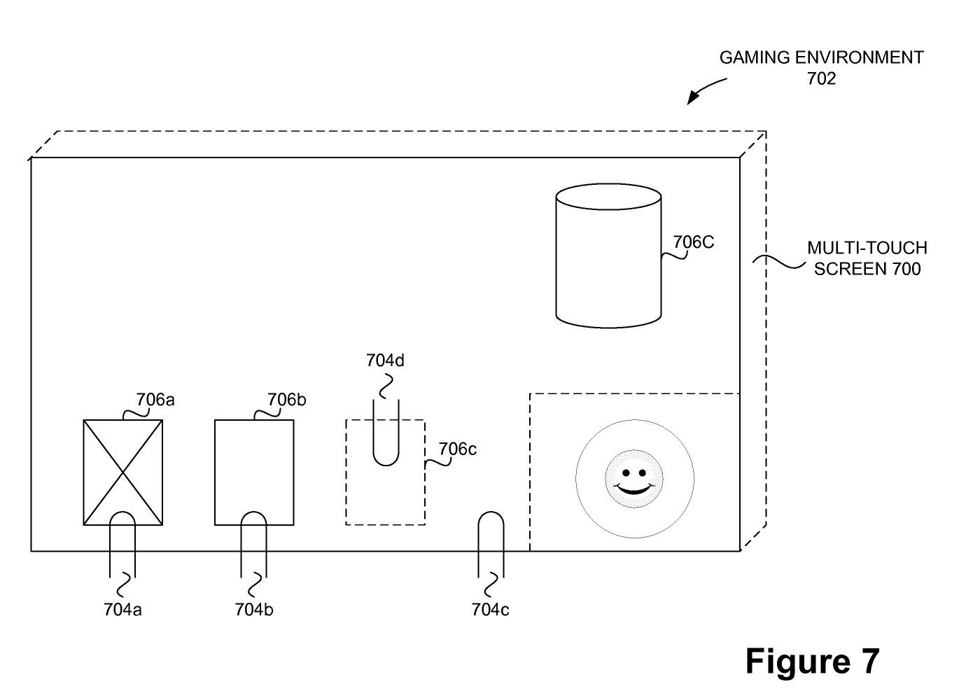

To further elaborate FIG. 7 depicts a multi-touch screen 700 in a gaming environment 702 in accordance with one embodiment of the invention. Referring to FIG. 7, multiple inputs 704a and 704b can be detected as acceptable inputs while input 704c is effectively ignored. By way of example, physical input 704a and 704b can be human fingers that touch the multi-touch screen 700 in order to turn and/or unturn game cards 706a and 706b. It should be noted that inputs 704a and 704b can be provided as multiple inputs, for example, simultaneously and/or in an overlapping manner where both touch the screen at a given time. It should further be noted that although input 704c touches the multi-touch screen 700, the input is not provided to the computer program (e.g., the poker game) because input is not received in a selected input location. Furthermore, it will be appreciated that although an object 704d can be provided in a selected input location 706c, it too can be effectively ignored because the shape and/or form of input may not be acceptable as input to the computer program. By way of example, the physical object 704d can represent a coffee cup which may be inadvertently in a input selection location 706c designated for manipulating a depicted playing card. The physical object 704d can, for example, be rejected as input because an acceptable form or shape (e.g., a finger or stylus) is not detected. In a similar manner, the coffee cup 706c may be placed in an upper right portion of the multi-touch screen 700 for the duration of the game and effectively ignored as no input would be provided to the computer program even though the touch screen 700 could sense its presence.

The various aspects, features, embodiments or implementations of the invention described above can be used alone or in various combinations.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

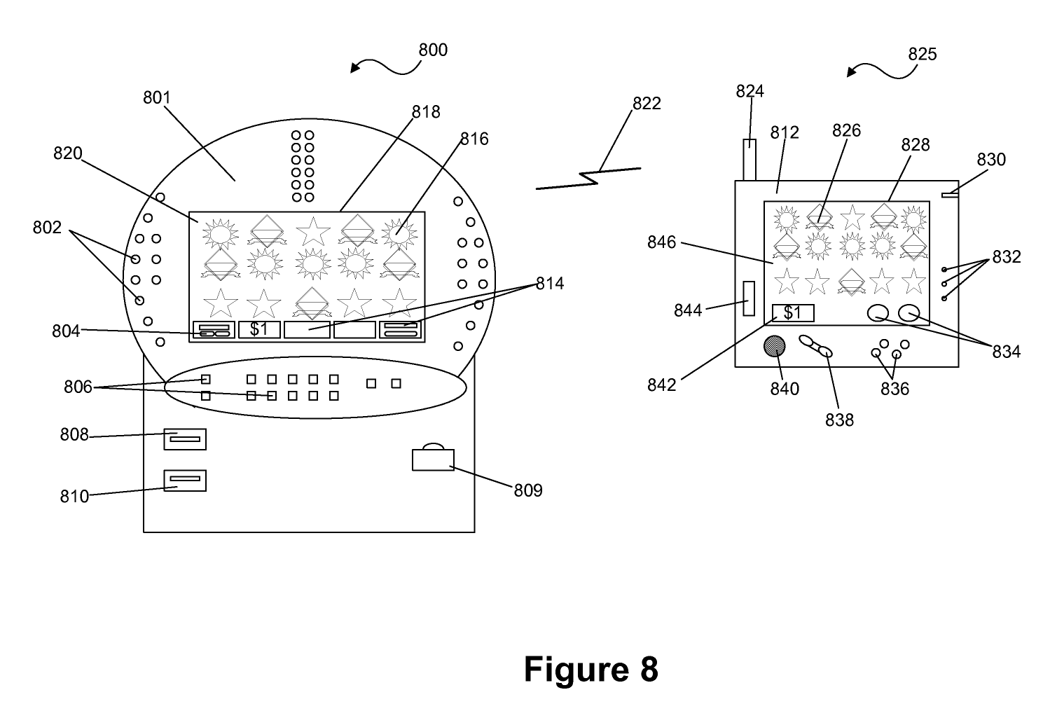

It should be noted that a wireless gaming device can be used to play a game in a gaming environment that uses the authentication techniques of the invention. FIG. 8 is block diagram of a gaming machine 800 in communication with a wireless game player 825. The wireless game player 825 is used as a remote extension to extend the game playing capabilities of gaming machine 800. Game outcomes for games of chance generated using licensed and regulated gaming software executed on the gaming machine 800 may be presented on the wireless game player 825 at remote locations from the gaming machine 800. Thus, a game generated on a gaming machine 800 may be presented on a display 818 located on the main cabinet 801 of the gaming machine and played using input mechanisms located on the main cabinet of the gaming machine. In addition, the game generated on the gaming machine may be presented on a display 828 located on a wireless game player in communication with the gaming machine and played with input mechanisms located on the wireless game player.

As an example, a game 816 may be presented on a display 818 located on gaming machine 800. The game 816 may be played using input mechanisms, such as input buttons 806 or touch screen interface buttons 804. The touch screen interface buttons 804 are activated using a touch screen 820 located over the display 818 of the gaming machine 800. Further, a game 826 may be presented on display 828 located on the wireless game player 825. The game 826 may be played using input mechanisms located on the wireless game player 825, such as 838 and 836 or touch screen interface buttons 834. The touch screen interface buttons 834 are activated using the touch screen 846 located over the display 828.

The game logic for a game presented on display 818 or display 828 is stored within the main cabinet 801 of the gaming machine 800. The game logic, which is typically regulated gaming software, is executed by a master gaming controller located within the main cabinet 801 of the gaming machine 800. A particular game executed by the master gaming controller may be presented on display 818 or, when the wireless game player 825 is activated, on display 828. When the same game is presented on display 818 or on display 828, the graphical presentations of the game may vary between the displays because of hardware differences. For instance, display 818 may by larger than display 828 allowing for higher resolution graphical output on display 818 as compared to display 828.

While playing a game 826 on the portable wireless game player 825, a player may move throughout the areas of a casino where wireless game play is enabled. For instance, a player may be able to play the game 826 with the wireless game player 825 in a restaurant, a keno parlor or a sports book. The player's position does not have to remain static while playing the game 826 on the wireless game player 825 and the player may be actively moving while games are played on the wireless game player 825.

When a game is played on the wireless game player of the present invention, such as 825, all random number generation (RNG) events, game outcomes, meter information, game related information, and all cash transactions are generated and maintained in the licensed (controlled) gaming machine (e.g. 800), and not the wireless game device. Thus, the wireless game player 825 may be considered a remote extension of the gaming machine's 800 display and input mechanisms. With a gaming machine with a remote extension, the gaming machine may operate in both a local mode and a remote mode. In the local operational mode, game play is presented using the display and input mechanisms located on the gaming machine. In the remote operational model, game play is presented using the display and input mechanisms located on the wireless game player. These two operational modes are described as follows.

During local game play on a gaming machine, a player may input money or indicia of credit into the gaming machine, indicate a wager amount, and initiate a game play. For example, to play the slot game 816 on gaming machine 800, a player may deposit money or indicia of credit using the bill validator 808, the card reader 810 or the coin acceptor 809. Status information 814 for the game, such as a game denomination and available credits may be displayed on display 818. Next, using input buttons 806 and touch screen interface buttons 804, the player may make a wager and initiate the game. The gaming machine determines a game outcome and then presents the game outcome to player on the display 818. For instance, after a slot game has been initiated, the video gaming machine calculates the final position of the reels (e.g. the game outcome), the reels on display 818 spin and then stop at pre-determined position. Based on the pre-determined outcome calculated by the master gaming controller, an award may be presented to the player. As another example, after a card game has been initiated, the video gaming machine 800 calculates a sequence of cards to be dealt to the player and card hands are dealt on the display 818. During the card game play, the player may use input mechanisms on the gaming machine 800 to hold or discard cards. After the card game is complete, an award may be presented to the game player.

The games presented on the gaming machine 800 may be enhanced by additional features. Light patterns, such as from lights 802, and sounds may be generated on the gaming machine 800 to enhance the game outcome presentation. In addition, during certain game events, a bonus game may be presented to the game player.

During remote game play on a gaming machine using a wireless game player such as 825, a player may input money or indicia of credit into the gaming machine, activate a wireless game player, indicate a wager amount on the wireless game player and initiate a game play on the wireless game player. For example, to play the slot game 826 on gaming machine 800 using the wireless game player 825, a wireless game play session is requested by the player. A wireless game play session may include one or more game plays on a wireless game player 825 connected to the gaming machine 800 via a wireless communication link 822. The wireless game play session request by the player may be made using an input mechanisms located on the gaming machine.

Prior to beginning, the wireless game play session, a player may be required to deposit money or indicia of credit to in the gaming machine in communication with the wireless game player. The deposited credits may be used during the wireless game play session. For instance, using the bill validator 808, the card reader 810 or the coin acceptor 809 located on the gaming machine 800, the player may provide an initial amount of credits to be used for a wireless game play session using the wireless game player 825. During game play on the wireless game player, a player wagers a certain amount of credits per game. Depending on the outcome of a particular game, the number of credits available for game play may be decreased or may be increased.

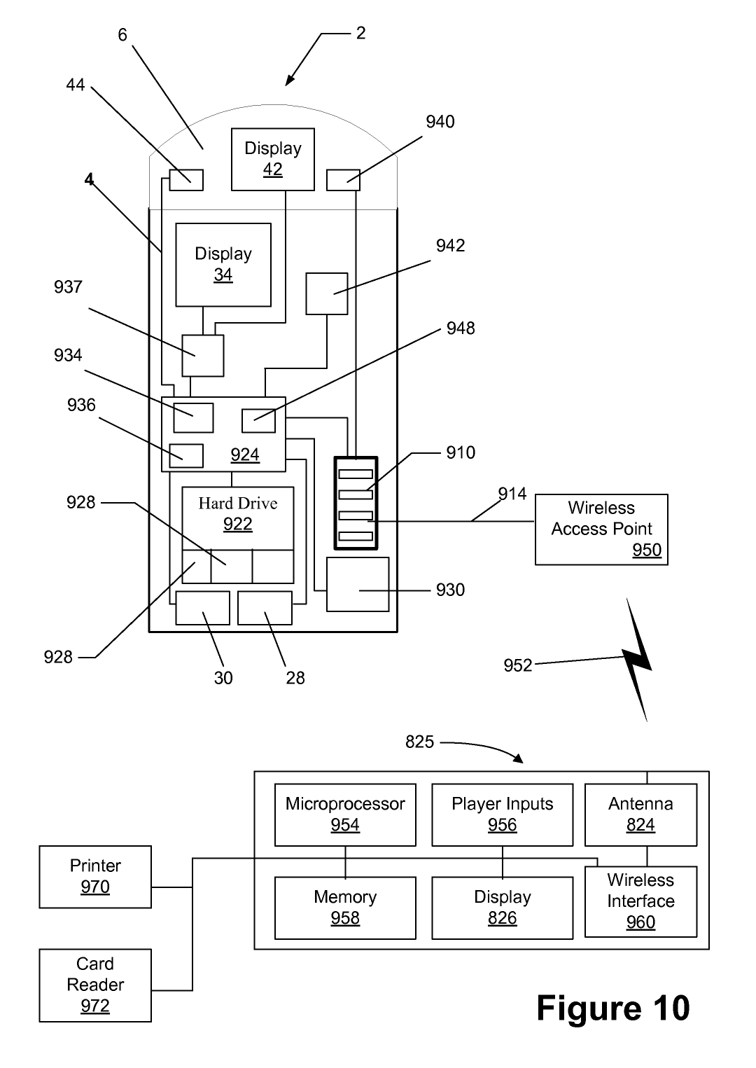

After a game player has used all of their credits during a wireless game play session and the player desires to continue the wireless game play session, the player may be required to return to the gaming machine to add additional credits. In other embodiments (See FIG. 10), a card reader or other input device may be attached to the wireless game player 825 and used to add credits to the gaming machine 800. For instance, a player may be able to enter a credit card number or debit card number and transfer funds to the gaming machine to be used as game credits via a touch screen interface on the wireless game player 825. Further, the wireless game player may include a card reader for scanning a magnetic strip on the debit card or credit card.

After establishing game credits on the gaming machine, the wireless game player 825 is activated. In some embodiments, authentication and verification of the user of the wireless game player is performed. For example, to enforce age restrictions imposed by a jurisdiction, the user may be verified and authenticated to use the game player. The wireless game player may have a biometric sensor (not shown) such as a fingerprint sensor. As part of the authentication process, the player may be asked to place their finger on the sensor located on located on the wireless game player. The fingerprint image is sent back to the controller in the machine for comparison. As another example, the wireless game player may include a smart-card reader that reads biometric smart cards (cards having a built-in fingerprint sensor). The smart card has all the personal information of the casino guest. Thus, the authentication could occur directly at the wireless game player. A description of a finger print reader as an identification device is provided in U.S. Pat. No. 6,488,585, which is incorporated herein in its entirety and for all purposes. Other types of verification methods such as a PIN number or a password may be used separately or in combination with biometric identification methods. Other biometric identification methods that may be used with the present invention include but are not limited to feature identification using a camera, retinal pattern identification using a retinal scanner, voice pattern identification input using a microphone and hand-writing recognition using a hand writing input pad.

For security, the wireless game player has an encrypted serial number (code), which is used to verify and authenticate the wireless game player. For additional security, an electronic key may be used with the device. With an electronic key system, the wireless game player device cannot be activated until the key is inserted into a receptacle on the game player. In addition, the wireless game player may have a small GPS (Global Positioning System) device to verify location of the device. Position verification may be used to insure the wireless game player is used only in legal gaming areas of the casino and to track lost or stolen devices. When the gaming machine detects that the wireless game player is in a restricted area, it may discontinue communications with the wireless game player. Further, the wireless game player may have an RF capacitive device built into the wireless game player. RF capacitive devices are often used in retail stores to prevent theft. When the wireless game player is passed through a protected doorway, an alarm may be sounded even when the power is off to the wireless game player. Other security features may be used on the wireless game player and are not limited to electronic keys, GPS sensors or RF capacitive devices described above. Verification and authentication may be required to start every wireless game play session. Further, there may be a non-play time limit. Once this time is exceeded, a verification and authentication cycle or process must be performed. The verification and authentication cycle may be performed for the player and the wireless game player, for only the player or for only the wireless game player. As another example, authentication and verification may be required after a certain number of games played on the gaming device or may be even be required at random intervals. When verification and authentication requirements are not satisfied during a wireless game play session, the game play session will typically be terminated.

In one embodiment, after the wireless game player is activated 825, the input mechanisms, such as the touch screen 820 and the input buttons 806, built into the gaming machine 800 are deactivated and a wireless game play session may begin. The display 818 on the gaming machine 801 may display an “out of order” message, an “operator” message or the display 818 may be blank to indicate the gaming machine is unavailable for game play. During remote game play on the wireless game player 825, gaming information necessary to present the game on the wireless game player, such as a graphical presentation of game outcome and meter information, is generated on the gaming machine 800 are transmitted to the wireless game player via wireless communication 822. The mathematical methods used to generate the game outcomes remain on the gaming machine 800. Further, gaming information required by the gaming machine 800 to the determine the game outcome, such as signals from input mechanisms located on the wireless game player, are transmitted from the wireless game player 825 to the gaming machine 800 via wireless communication 822.

During game play on the wireless game player 825, status information 842 for the game 826, such as a game denomination and available credits may be displayed on display 828. The status information 842 and the game 826 displayed on the wireless game player 825 may appear similar to what is displayed on the gaming machine 801 but is not necessarily identical to what is displayed on the gaming machine 800. Next, using input buttons, such 834, 836 and 838, the player may make a wager and initiate the game. In one embodiment of the present invention, the touch screen interface buttons 834 may be based on a web-browser interface.

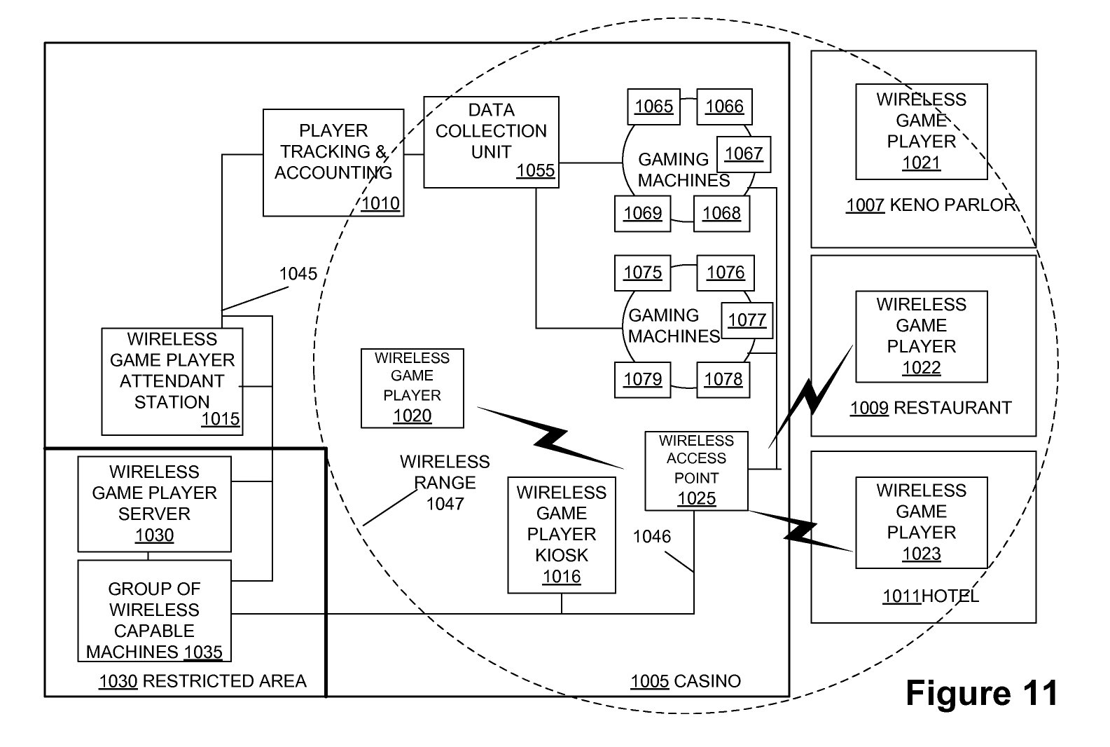

After a game has been initiated on the wireless game player 825, via antenna 824, a wireless communication 822 containing the wager and initiate game inputs is sent to the gaming machine 800. In response, to the wager and the initialization of a game, the gaming machine 800 generates a game outcome including an award and possibly a bonus game. Instructions for displaying the game outcome and bonus game are sent in one or more wireless communications 822 to the wireless game player 825. The one or more wireless communications may be a series of information packets. The format of the information packets will vary according to the wireless communication standard used. Details of a wireless network for providing wireless communications is described with respect to FIG. 11. To illustrate the play of a particular game, a slot game and a card game are described. However, the present invention is not limited to these games as nearly any type of game that can be played on a video gaming machine may also be played on the wireless game player 825. When a slot game 826 has been initiated on the wireless game player 825, the gaming machine 800 calculates the final position of the reels (e.g., the game outcome). The gaming machine may send instruction to the wireless game player to spin the reels on display 828 spin and then stop the reels at a pre-determined position. Based on the final position of the reels calculated by the master gaming controller located on gaming machine 800, an award may be presented to the player. In addition, during certain game events, a bonus game may be presented to the game player as part of the slot game. As another example, after a card game has been initiated on the wireless game player 825, the video gaming machine 800 calculates a sequence of cards to be dealt. The gaming machine 800 sends wireless communications 822 to the wireless game player 825 indicating card hands to be dealt on the display 728. During the card game play, the player may use input mechanisms on the wireless game player 825 to hold or discard cards. After the card game is complete, an award may be presented to the game player. A bonus game may also be incorporated into the card game.

When a customer does not wish to use the wireless game player 825 anymore, the customer can terminate the wireless game play session using the touch screen 846 and deactivate the wireless game player 825. As described above, the wireless game player 825 may automatically terminate a wireless game play session and deactivate itself after a period of inactivity. After roaming with the wireless game player 825, the customer may return to the gaming machine providing the wireless game play session and wish to resume play on the main display of the gaming machine. In this case, the customer may depress a “return” button on the wireless game player 825 and after a verification cycle the player can begin playing at the gaming machine again.

The games presented on the wireless game player 825 may be enhanced by additional features. For instance, light patterns and sounds from the audio output 840 may be generated to enhance the game outcome presentation and add excitement to the games played on the wireless game player 825. Further, the wireless game player may include an audio output interface for connecting headphones. As part of a game outcome presentation, sounds may be transmitted through the audio output interface to headphones worn by the game player.

Details of the wireless game player hardware are now described. The wireless game player 825 is generally a hand-held device. It consists of a housing 812, display 828, touch screen 846, switch panel 844, battery, wireless communication interface, and controller. In one embodiment of the present invention, a modified DT Research WebDT pad (DT Research, Inc., Milpitas, Calif.) is used as a wireless game player. However, the present invention is not limited to the DT research WebDT pad as other hand-held wireless devices such as personal digital assistants (PDA) may also be used.

In one embodiment, the wireless game player may be approximately 10.5×9.5×1.0 inches in size, weigh 3 pounds and use a 10.4 inch color LCD touch screen display. Typically, an 8 inch to 10.4 inch display provides a sufficient viewing area without reducing the size of the character fonts to a point where they are unreadable by most players. The touch screen (sensor) 846 is overlaid on the displayable surface of the LCD 828. Other display technologies can be used instead of LCD, plus some display technologies will incorporate a built-in touch screen (internal vs. external). To activate the touch screen 846, a stylus 830 may be used, but most people will use their fingers.

Audio is available via the small built-in speaker 840 or an external headset. Lighting schemes, such as arrays of LEDs, may be added to the wireless game player 825 to provide visual effects and to communicate status information to a game player. Status information, such as a battery level and connection status, may be provided by the status lights 832. The layout and number of the input buttons, including 838 and 836, is variable. In FIG. 8, the configuration of the input buttons on the gaming machine 800 and wireless game player are different. In one embodiment of the present invention, the input buttons on the wireless game player 825 may be configured in a manner similar to input buttons located on the gaming machine. Further, other devices on the wireless game player, such as the audio output 840, the status lights 832, the antenna 824 and the on/off switch 844 may be located at other locations on the housing 812 depending on the design of the wireless game player.

In one embodiment, the battery will last 5 hours between charging. Charging of the wireless game player may be accomplished by setting the wireless game player in a special storage cradle. The cradles may be in the form of storage bins located in a special area, located at the gaming machine or built as holders located on a desk, counter or table. For instance, a storage cradle for charging the wireless game player may be located in a keno parlor, restaurant tables or sports book. When the wireless game player is placed in a storage cradle it may used while being charged.

The wireless game player 825 can, for example, use an IEEE 802.11b compliant wireless interface. It is a 2.4 Ghz Direct Sequence Spread Spectrum radio system. It has a range of up to 330 ft (inside) from any access point. The data rate is 11 Mbps. IEEE 802.11b is a commonly used radio standard. Other exemplary wireless standards that may be used include IEEE 802.11a, IEEE 802.11x, hyperlan/2, Bluetooth, IrDA, and HomeRF.

In the example above, local gaming and remote gaming on gaming machine 800 has been described in a mutually exclusive manner. Therefore, when local gaming is enabled, remote gaming is disabled and when remote gaming is enabled, local gaming is disabled. However, the present invention is not so limited. Gaming machines that support only remote gaming and not local gaming may be used with the present invention. These gaming machines (see FIG. 10) may be located away from the casino floor. Further, a gaming machine may support simultaneously a plurality of remote gaming devices for game play and not just a single remote gaming device. Finally, gaming machine may be used that simultaneously provide both remote game play and local game play. For instance, one game player may use a gaming machine for local play while another game player is using a wireless game player connected to the gaming machine to play remotely.

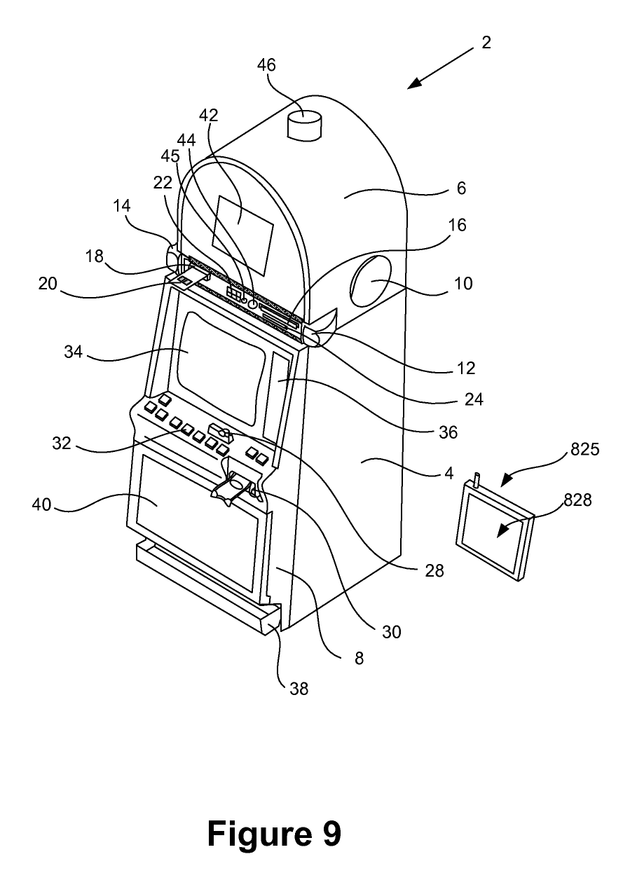

In FIG. 9, another video gaming machine 2 suitable for use with the present invention is shown. Referring to FIG. 9, more details of a gaming machine as well as additional gaming services that may be provided with a gaming machine providing remote game play sessions are described. For instance, player tracking services may be provided on gaming machines of the present invention and player tracking points may be accumulated during a wireless game play session. Further, using a player tracking device located on a gaming machine, a player may be able to request a wireless game player for use in a wireless game play session.

Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The main display monitor 34 will typically be a cathode ray tube, high resolution flat-panel LCD, or other conventional electronically controlled video monitor. The gaming machine 2 includes a top box 6, which sits on top of the main cabinet 4. A second display monitor 42 may be provided in the top box. The second display monitor may also be a cathode ray tube, high resolution flat-panel LCD or other conventional electronically controlled video monitor. In addition, the gaming machine 2 is designed to communicate to the wireless game player 825 with display 828. The wireless game player 825 effectively provides a remote extension to gaming machine 2.

Typically, after a player has initiated a game on the gaming machine, one purpose of the main display monitor 34, the second display monitor 42 or the remote display 828 is the visual display of a game outcome presentation, including bonus games, controlled by a master gaming controller 924 (FIG. 10). Also, the main display monitor 34, the second display monitor 42 and the remote display 828 may also be utilized to display entertainment content independent of the game outcome presentation. For example, broadcast events, including television programming, may be provided to the main display monitor 34, the secondary display monitor 42 or the remote display 828. The broadcasts events may be sent to the gaming machine 2 via a cable link or other suitable link from outside of the gaming machine. All or some subset of the programming provided by a television broadcaster may be displayed as entertainment content on one or more of the video displays.

Television programming content of particular interest to casino operators and game players may include, for example, sporting events, talk shows, game shows, soap operas, advertisements, situation comedies, etc. In addition, broadcasts of competitive events on which the player can wager may be displayed. For example, dog racing or horse racing events may be displayed as content on the remote display 828. In such events, typically, there is a rather long down time between races. During this period, the player may play the wireless game player 825 connected to the gaming machine. Also, the television programming entertainment content may be displayed while a player is engaged in playing a game on the wireless game player 825 or between games. Similarly, the entertainment content may include information available on the Internet, including the World Wide Web, for more technologically sophisticated players.

Returning to the gaming machine in FIG. 9, the information panel 36 may be a back-lit, silk screened glass panel with lettering to indicate general game information including, for example, the number of coins played. The bill validator 30, player-input switches 32, video display monitor 34, and information panel are devices used to play a game on the game machine 2 including the wireless game player 825. The devices are controlled by a master gaming controller (see FIG. 10), housed inside the main cabinet 4 of the machine 2. Many possible games, including traditional mechanical slot games, video slot games, video poker, video pachinko, multiple hand poker games, video pai-gow poker, video black jack, video keno, video bingo, video roulette, video craps, video card games and general games of chance, may be provided with gaming machines of this invention. These games may be played using the wireless game player 825.

General games of chance refer to games where a player makes a wager on an outcome of the game. The outcome of the game of chance may be affected by one or more decisions may be the player. For instance, in a video card game, the player may hold or discard cards which affects the outcome of the game.

The top box 6 houses a number of devices, which may be used to add features to a game being played on the gaming machine 2, including speakers 10, 12, 14, a ticket printer 18 which may print bar-coded tickets 20, a key pad 22, a florescent display 16, a camera 45, microphone 44 and a card reader 24 for entering a magnetic striped cards. The speakers may be used to project sound effects as part of a game outcome presentation. The keypad 22, the florescent display 16 and the card reader 24 may be used for to enter and display player tracking information. As another example, the player may enter playing tracking information and identification information using the card reader 24 and the main video display 34 where the main video display may be used as a touch screen to enter information. Player tracking information may be entered into the gaming machine before a player initiates a game on the gaming machine. Typically, the player's incentive to enter player tracking information into the gaming machine 2 is potential rewards related to the amount of a player's game play.

The top box also includes a candle 46. The candle is a light that may be activated by the master gaming controller on the gaming machine. In one embodiment, an antenna (not shown) may be installed in the candle. The antenna may be used to provide wireless game play sessions to one or more wireless game players in communication with the gaming machine 2 via the antenna.

In addition to enabling player tracking services, the key pad 22, the florescent display 16 and the card reader 24 may be used to enter identification information that enables a player to access entertainment content or receive personal messages on the gaming machine independent of a game play and game outcome presentation on the gaming machine 2. For example, a player may enter a personal identification number into the gaming machine 2 using the key pad 22 that allows the player to receive entertainment content such as viewing a movie or a broadcast event. As another example, after entering the personal identification number, the player may be allowed to receive a personal message indicating a table is ready at a restaurant in the casino or to receive a personal message containing information on a sporting event such as a score of personal interest to the player utilizing the gaming machine.

In one embodiment of the present invention, the player tracking services and related gaming service described above may be provided via a touch screen interface on the wireless game player 825. For instance, the wireless game player 825 may include a card reader for reading a player tracking card and player tracking identification information may be provided via a touch screen interface on the wireless game player. Further, the player may be able to access player tracking information using the wireless game player 825.

In addition to the devices described above, the top box 6 may contain different or additional devices than shown in the FIG. 9. For example, the top box may contain a bonus wheel or a back-lit silk screened panel which may be used to add bonus features to the game being played on the gaming machine. During a game, these devices are controlled and powered, in part, by circuitry (not shown) housed within the main cabinet 4 of the machine 2. Understand that gaming machine 2 is but one example from a wide range of gaming machine designs on which the present invention may be implemented. For example, not all suitable gaming machines have top boxes or player tracking features. Further, some gaming machines have two or more game displays—mechanical and/or video, while others are designed for bar tables and have displays that face upwards. As another example, a game may be generated in on a host computer and may be displayed on a remote terminal or a remote computer. The remote computer may be connected to the host computer via a network of some type such as the Internet. Those of skill in the art will understand that the present invention, as described below, can be deployed on most any gaming machine now available or hereafter developed.

Returning to the example of FIG. 9, when a user selects a gaming machine 2, he or she inserts cash through the coin acceptor 28 or bill validator 30. Additionally, the bill validator may accept a printed ticket voucher which may be accepted by the bill validator 30 as an indicia of credit. Once cash has been accepted by the gaming machine, it may be used to play a game on the gaming machine. Typically, the player may use all or part of the cash entered into the gaming machine to make a wager on a game play. Depending on the amount of the wager on a game or for a fee, a player may be able to access various entertainment content sources for a length of time. For example, a wager on a game above a certain threshold amount may enable a player to watch a broadcast event or to access the World Wide Web for up to 5 minutes after each wager on the gaming machine 2. In addition, cash or indicia of credit entered into the gaming machine may be used to purchase entertainment content independent of a wager made on a game on the gaming machine. For example, for a 10 dollar fee, a player may view a movie on the gaming machine. While watching the movie on the gaming machine, the player may play games on the gaming machine 2 or the wireless game player 825 or just watch the movie.

During the course of a game, a player may be required to make a number of decisions which affect the outcome of the game. For example, a player may vary his or her wager, select a prize, or make game-time decisions which affect the game play. These choices may be selected using the player-input switches 32, the main video display screen 34 or using some other device which enables a player to input information into the gaming machine including a key pad, a touch screen, a mouse, a joy stick, a microphone and a track ball.

When a game is not being played on the gaming machine or during particular game operational modes, the player may select an entertainment content source using the above mentioned inputs where the entertainment content is independent of a game being played on the gaming machine. The entertainment content source may include, for instance, a CD player, an FM/AM tuner, a VHS player, a DVD player, a TV tuner, a musical jukebox, a video jukebox, a computer, a server and a media software application. It will be appreciated, however, that any information source may be utilized. Entertainment content from these sources may be selected and displayed on the wireless game player 825. For instance, a player may listen to music from the FM/AM tuner via headphones connected to the wireless game player.

Before playing a game, a player may select the video jukebox, which may contain a DVD player loaded with many DVDs, as the entertainment content source and preview a movie on at least one of the display screens on the gaming machine 2. The DVDs may be stored on the gaming machine 2 or in a central location separate from the gaming machine. The visual display of the output from the video jukebox may be viewed by the player on the main video display screen 34, the secondary video display screen 42 or the remote display 828. The sound for the movie may be projected by the speakers 10, 12 and 14 on the gaming machine or a player may listen to the movie through headphones. As described above, the wireless game player 825 may include an interface for audio output such as a headphone jack.

The game player may also use the player input switches 32, keypad 22, and other input devices to control a feature of the entertainment content. For example, when the entertainment content is a movie, the player input switches 32 and keypad may be operated to fast forward, stop or pause the movie. When the entertainment content is accessing the World Wide Web through a web-browser, the player input switches 32 and keypad may be used to operate the web-browser. Input switches, as described with respect to FIG. 8, on the wireless game player 825 may also be used to control these functions.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, throbbing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18. When a player is using the wireless game player 825, credits available during the wireless game play session are stored on the gaming machine. To redeem credits, for instance to receive a printed ticket voucher, the player may have to return to the gaming machine 800 or a printing station supporting communications with the wireless game player 825. In some embodiments of the present invention, a player may be able to electronically transfer credits to a remote account accessible by the player.

FIG. 10 is a block diagram of the internal components of a gaming machine 2 and a wireless game player 825. Components that appear in FIGS. 8 and 9 are identified by common reference numerals. A master gaming controller 924 controls the operation of the various gaming devices and the game presentation on the gaming machine 2. In the present invention, the wireless game player 825 is one of the gaming devices the master gaming controller 924 controls. The master gaming controller 924 may communicate with the wireless game player 825 via a wireless communication link 952. The wireless communication link may use a wireless communication standard such as but not limited to IEEE 802.11a, IEEE 802.11b, IEEE 802.11x (e.g. another IEEE 802.11 standard such as 802.11c or 802.11e), hyperlan/2, Bluetooth, and HomeRF.

As described above, in the present invention, the gaming machine may operate in a local operational mode where a game is presented on a local display screen, such as 34 or 42, a remote operational mode where a game is presented on the wireless game player 825 or combinations thereof. When the gaming machine 2 is in a local operational mode, using a game code and graphic libraries stored on the gaming machine 2, the master gaming controller 924 generates a game presentation which is presented on the displays 34 and 42. The game presentation is typically a sequence of frames updated at a rate of 60 Hz (60 frames/sec). For instance, for a video slot game, the game presentation may include a sequence of frames of slot reels with a number of symbols in different positions. When the sequence of frames is presented, the slot reels appear to be spinning to a player playing a game on the gaming machine. The final game presentation frames in the sequence of the game presentation frames are the final position of the reels. Based upon the final position of the reels on the video display 34, a player is able to visually determine the outcome of the game.

Each frame in sequence of frames in a game presentation is temporarily stored in a video memory 936 located on the master gaming controller 924 or alternatively on the video controller 937. The gaming machine 2 may also include a video card (not shown) with a separate memory and processor for performing graphic functions on the gaming machine. Typically, the video memory 936 includes 1 or more frame buffers that store frame data that is sent by the video controller 937 to the display 34 or the display 42. The frame buffer is in video memory directly addressable by the video controller. The video memory and video controller may be incorporated into a video card which is connected to the processor board containing the master gaming controller 924. The frame buffer may consist of RAM, VRAM, SRAM, SDRAM, etc.

The frame data stored in the frame buffer provides pixel data (image data) specifying the pixels displayed on the display screen. In one embodiment, the video memory includes 3 frame buffers. The master gaming controller 924, according to the game code, may generate each frame in one of the frame buffers by updating the graphical components of the previous frame stored in the buffer. Thus, when only a minor change is made to the frame compared to a previous frame, only the portion of the frame that has changed from the previous frame stored in the frame buffer is updated. For example, in one position of the screen, a 2 of hearts may be substituted for a king of spades. This minimizes the amount of data that must be transferred for any given frame. The graphical component updates to one frame in the sequence of frames (e.g. a fresh card drawn in a video poker game) in the game presentation may be performed using various graphic libraries stored on the gaming machine. This approach is typically employed for the rendering of 2-D graphics. For 3-D graphics, the entire screen is typically regenerated for each frame.

Pre-recorded frames stored on the gaming machine may be displayed using video “streaming”. In video streaming, a sequence of pre-recorded frames stored on the gaming machine is streamed through frame buffer on the video controller 937 to one or more of the displays. For instance, a frame corresponding to a movie stored on the game partition 928 of the hard drive 922, on a CD-ROM or some other storage device may streamed to the displays 34 and 42 as part of game presentation. Thus, the game presentation may include frames graphically rendered in real-time using the graphics libraries stored on the gaming machine as well as pre-rendered frames stored on the gaming machine 2.

When the gaming machine is in a remote operational mode and a game is presented on a display 826 of the mobile wireless game player 825, video frame data may be directly streamed from gaming machine 2 via the wireless interface 948 and wireless access point 950 to the wireless game player 825 via wireless interface 960. The video frame data may be stored in a memory 958 on the wireless game player 958 and then displayed on the display 825. The video frames sent to the wireless game player may be reduced in resolution and compressed to reduce the communication band-with necessary to transmit the video frames to the wireless game player 825.

In another embodiment, the video frames to present a game of chance may be rendered locally on the wireless game player 825. Graphical programs that allow a game to be rendered on the wireless game player may be stored in memory 958. For instance, the memory 958 may store a graphical program to render a slot game or a graphical program to render a card game. The memory 958 may store graphical programs for one or more games. For instance, the memory 958 may store graphical routines for a plurality of games supported by gaming machine 2. In one embodiment, the wireless game player 825 may be configured to allow different graphical programs for presenting different games to be downloaded into memory 958.

In other embodiments, the wireless gaming device may include a detachable memory and interface for the detachable memory. The detachable memory may store graphical applications for one or more games. Thus, to enable a particular game, a detachable memory storing graphical applications for the particular game may be inserted in the detachable memory interface on the wireless game player 825. The detachable memory may be in the form of read-only cartridges and may include a locking mechanism that prevents removal of the cartridge by the player. Thus, only authorized gaming personnel may be able to change a cartridge in the wireless game player.

The wireless game player may include a video card (not shown) to aid in the rendering process. The video card may include one or more graphical processing units that are used to render images to the display 826. The video card may be used to render 2-D graphics and 3-D graphics on the wireless game player 825. Graphical processing may also be performed by microprocessor 954 including 2-D and 3-D graphical rendering. Some images may be pre-rendered and stored on the wireless game player 825 and activated by a small string of commands from the gaming machine 2. Animations, such as reel rotation for a slot game, may be performed by routines on the wireless game player 825.

When the game graphics are rendered locally on the wireless game player 825, all of the game logic necessary to present the game of chance still resides on the gaming machine 2. Any switch or touch input necessary for game play on the wireless game player 825 (e.g., making a wager, initiating a game, holding cards, drawing cards, etc.) is transmitted 2 from the wireless game player 825 to the gaming machine 2. The gaming machine 2 executes gaming logic associated with the switch or touch inputs and sends the result back to the wireless game player 825. The wireless game player 825 verifies information sent from the gaming machine. In general, communication between the gaming machine 2 and the wireless game player 825 is encrypted. For any screen image or input involving the outcome of the game or betting, an additional level of transmit and receive data verification may be used by the wireless game player 825 and the gaming machine 2 to ensure the correct information is displayed on the wireless game player 825.

For illustrative purposes only, a series of commands between the gaming machine 2 and the wireless game player is described. The present invention is not limited to the commands described in this example. In response to input from player inputs 956 located on the wireless game player 825, the master gaming controller 924 may send a series of instructions to the wireless game player 825 that allow the game of chance to be rendered on display 826 of the wireless game player 825. The master gaming controller may also send instructions controlling audio output and other gaming devices on the wireless game player 825. For instance, for a slot game, the master gaming controller 924 may calculate symbol position, reel position, start and stop rotation for a number of reels. Then, the master gaming controller 925 may send one or more messages via the wireless communication link 952 to the wireless game player 825 with instructions such as 1) “render reels spinning”, 2) “render reel 1 at position A”, 3) “render reel 2 at position B”, 4) “render reel 3 at position C”, 5) “output audio B”, 6) “display light pattern A,” etc. The instructions may be processed and implemented by the microprocessor 954 using graphical software stored on the wireless game player 825.

In one embodiment, the wireless game player may be connected to a number of peripheral devices such as a printer 970 or a card reader 972. The printer 970 and the card reader 972 may communication with the wireless game player via a wire communication protocol such as serial, parallel, USB, Firewire or IEEE 1394. The peripheral devices, such as 970 and 972, may be controlled by the microprocessor 954 according to inputs received by the wireless game player and may also be controlled by the master gaming controller 924 on the gaming machine 2.

For gaming machines, an important function is the ability to store and re-display historical game play information. The game history provided by the game history information assists in settling disputes concerning the results of game play. A dispute may occur, for instance, when a player believes an award for a game outcome was not properly credited to him by the gaming machine. The dispute may arise for a number of reasons including a malfunction of the gaming machine, a power outage causing the gaming machine to reinitialize itself and a misinterpretation of the game outcome by the player. In the case of a dispute, an attendant typically arrives at the gaming machine and places the gaming machine in a game history mode. In the game history mode, important game history information about the game in dispute can be retrieved from a non-volatile storage on the gaming machine and displayed in some manner to a display on the gaming machine. The game history information is used to reconcile the dispute.

During the game presentation, the master gaming controller 924 may select and capture certain frames to provide a game history. These decisions are made in accordance with particular game code executed by controller 924. The captured frames may be incorporated into game history frames. Typically, one or more frames critical to the game presentation are captured. For instance, in a video slot game presentation, a game presentation frame displaying the final position of the reels is captured. In a video blackjack game, a frame corresponding to the initial cards of the player and dealer, frames corresponding to intermediate hands of the player and dealer and a frame corresponding to the final hands of the player and the dealer may be selected and captured as specified by the master gaming controller. Details of frame capture for game history applications are provided in U.S. Pat. No. 6,863,608, which is incorporated herein in its entirety and for all purposes.

In general, the gaming machine 2 maintains transaction logs of all events and game play. In some embodiments, as described above, the gaming machine may generate and store video frames as a game history record. The video frames may correspond to gaming information displayed on the wireless game player 825. During a wireless game play session, when the wireless game player 825 stops responding to the gaming machine 2, the game presented on the wireless game player 825 stops. The wireless game player 825 may stop responding to the gaming machine 2 because the wireless game player 825 is out-of-area reception, a battery level is low on the wireless game player, a power failure on the gaming machine 2 and other factors. To continue an interrupted game, the wireless game player 825 may ping the gaming machine 2 to reestablish communications and start the verification and authentication cycle as previously described. In the case of a dispute, the player may have to return to the gaming machine 2 so that game history records on the gaming machine can be accessed.

FIG. 11 is a block diagram of a network of gaming machines and wireless game players. Gaming machines 1065, 1066, 1067, 1068, 1069, 1075, 1076, 1077, 1078 and 1079, located in a floor area of casino 1005, support wireless game play and are connected to a wireless access point 1025. The gaming machines 1065, 1066, 1067, 1068, 1069, 1075, 1076, 1077, 1078 and 1079 are also connected to a player tracking system 1010 via a data collection unit 1055. Thus, game play on a wireless game player, such as 1020, in communication with one of the gaming machines on the casino floor may generate player tracking points. Further, a player using a game player, such as 1020, may be able to utilize services traditionally offered through player tracking devices on gaming machines such as a drink request. To provide the player tracking services, a player tracking service interface may be displayed on the touch screen of the wireless game player. Details of player tracking services and other gaming services that may be provided through a wireless game player of the present invention are described in U.S. Application No. 6,908,387, which is incorporated herein in its entirety and for all purposes.

The gaming machines located on the casino floor may also be connected to other remote servers such as but not limited to cashless system servers, progressive game servers, bonus game servers, prize servers, Internet, an entertainment content server, a concierge service server and a money transfer server and the like. Game services offered by the remote servers connected to the gaming machines may also be offered on wireless game players such as 1020. For instance, a game player may participate in a progressive game using the wireless game player 1020. In another example, a game player may be able to perform a cashless transaction enabled by a cashless system, such as the EZPAY™ cashless system (IGT, Reno Nev.), using a wireless game player.

In one embodiment, the gaming machines 1065, 1066, 1067, 1068, 1069, 1075, 1076, 1077, 1078 and 1079 connected to the access point 1025 are each provided with a wireless game player, such as 1020, 1021, 1022 and 1023. The gaming machines use a common wireless access point 1025. In this case, the access point device is also a multi-port switch. So, each machine has an Ethernet connection to the access point 1025.

In another embodiment of the present invention, an antenna may be built into a candle located on top of a gaming machine or some other location in the gaming machine. The antenna may be used as a wireless access point for wireless game play on one or more gaming machines. As an example, an antenna may be installed in the candle of gaming machine 1067 to be used as a wireless access point for wireless game play on gaming machines 1065, 1066, 1067, 1068 and 1069. A single gaming machine with an antenna may be used as part of a larger network of gaming devices providing wireless game play or may be used independently of a larger network. The antenna can, for example, be provided in accordance with the techniques described in the U.S. Pat. No. 5,605,506, entitled “CANDLE ANTENNA.”

To obtain a wireless game player on one of the gaming machines on the casino floor, a player may request a wireless game player via a service call on the gaming machine such as through the player tracking system. The request may go to a remote location, such as a terminal at a wireless game player attendant station 1015 and an attendant may then bring a wireless game player to the gaming machine where the request for wireless game play has been made. The request may be routed to the attendant station 1015 via the wireless game player server 1030. When a wireless game player server 1030 is not used, the request may be sent directly to the attendant station 1015. As another example, when a request for wireless game play is made, a light on the gaming machine such as the candle on top of the gaming machine may be activated. In this case, a passing attendant may bring the game player a wireless game player. In yet another embodiment, a player may make a request for a wireless game player on a terminal at a wireless game player kiosk 1016.

Prior to enabling the network connection for the wireless game play, a person or a system program may determine the customer is eligible to use the wireless game player and verify their eligibility. For instance, most gaming jurisdictions include age eligibility rules which must be obeyed. As another example, eligibility to use a wireless game player may be based upon a player's value to a casino such as a status in a player tracking club. When authentication is required, the information is loaded from the system (could be a smart-card reader on the gaming machine) or a message appears on the gaming machine instructing the customer to provide information. For example, the gaming machines could have a fingerprint sensor located on the front panel or another biometric device. When required, the gaming machine could instruct the customer that it needs a fingerprint image or other biometric information before the customer may use the wireless game player. Information obtained through biometric sensors located on the gaming machine may be compared with information contained in a customer's biometric file. In some embodiments, the biometric information file may be downloaded to the gaming machine from a remote server and the biometric comparison may be performed on the gaming machine, the gaming machine may send biometric information to a remote server where the biometric comparison is performed, or combinations thereof.

In some instances, gaming machines supporting wireless game players may be located in a high-roller area (e.g., very valued customers) and the machines may have a specially designed stand where the wireless game players are stored. The wireless game players may be enabled by an attendant or may automatically be enabled when the casino customer inserts their player-tracking card into the gaming machine (special customer). As with the gaming machines located on the casino floor, the player-tracking system or some other remote gaming device may download the customer's biometric file to the gaming machine or the gaming machines could have a fingerprint sensor located on the front panel. When required, the gaming machine may instruct the customer that it needs a fingerprint image before the customer use the wireless game player.

To establish remote operations on the wireless game player, the gaming machine may ping the wireless game player with a series of communications. In one embodiment, once this operation is completed, the game play is transferred to the wireless game player. The screen of the gaming machines may go black (perhaps with a out-of-service message) and all customer cash and switch controls are locked out (nobody can use them). The master gaming controller on the gaming machine will continue to play the games, perform all the outcome determination and cash transaction (bets & credits), and maintains all the meter information. However, all the front panel and display data is channeled to the wireless game player. In one embodiment, when the gaming machines credit balance reaches zero, the customer is required to return to the gaming machine and insert more money. To enter more money, first, the local gaming machine controls are activated by the player or an attendant. In jurisdictions where the customer can use a debit or smart card to add money to a gaming machine, a card reader (smart card) connected to the wireless game player may be used to perform this function. In general, during a wireless game play session, the gaming machine communicates continuously with the wireless game player. In one embodiment, a web browser is used to display input switch commands. The displayed information on the wireless game player may come over from the gaming machine as HTML page information. Therefore, the wireless game player may use web-based transactions.

Additional details of a wireless game play network are described in the following paragraphs. The wireless game play network is shown in FIG. 11 is only one example of many possible embodiments of the present invention. The gaming machines and other gaming devices supporting wireless game play on wireless game players comprise a wireless game play network. The wireless game play network may be a part of a larger system network. The larger system network may provide the capability for a large number of gaming machines throughout a casino to be on the same wireless game play network. High-gain antennas and repeaters may be used to expand the range of the wireless game players allowing them to work in all areas of a casino/hotel complex, including hotels rooms and pool area. Racetracks, large bingo parlors and special outdoor events may also be covered within the wireless game play network allowing wireless game play in these areas.

The wireless game play network may also include wired access points that allow a wireless game player to be plugged directly into the network. For example, a wireless game player may include an Ethernet connector that may be directly plugged into the network segment 1046. The direct network connectors may be provided with cradles used to charge the wireless game player. The charging cradles may be located at many locations within the wireless game play network.

In FIG. 11, the range of the wireless access point 1025 is denoted by a circle 1047 used in the wireless game play network. Many such access points may be used in a wireless game play network depending upon the network topography. For instance, due the size of a particular casino and the area covered by a single access point, there could be other access points used as repeaters located throughout the casino and hotel. In addition, the wireless access point could also be connected to an existing network. After receiving an active wireless game player, a player may use the wireless game player in the areas of casino 1005 within the circle 1047. Further, the player may use the wireless game player, if approved by a local gaming jurisdiction, in the areas of a keno parlor 1007, a restaurant 1009, and a hotel 1011, which are within the circle 1047. While using the wireless game player, a player may wander to different locations within circle 1047 such as from the casino 1005 to the restaurant 1009.

In general, wireless game play in the wireless game play network is enabled by gaming devices executing licensed and regulated gaming software. However, the gaming devices supporting wireless game play are not limited gaming machines, such as 1065, 1066, 1067, 1068, 1069, 1075, 1076, 1077, 1078 and 1079 located on a casino floor. Special wireless-only gaming machines 1035 mounted in racks or containers connected to a wireless gaming network may be used to support wireless game play using wireless game players. The wireless-only gaming machines 1035 may not offer local game play. For instance, the wireless-only gaming machines 1035 may not include display screens. However, the wireless-only gaming machines are still regulated and licensed in a manner similar to traditional gaming machines. As another example, a wireless game player server 1030 with multiple processors may be used to support simultaneous game play on a plurality of wireless game players. The wireless-only gaming machines 1035 and the wireless game play server 1030 may be located in a restricted area 1030 of the casino 1005 and may not be generally accessible to game players.

The wireless-only gaming machines 1035 and wireless game play server 1030 are connected the wireless access point 1025 via a connection 1046. The wireless-only gaming machines 1035 and wireless game play server are also in communication with a wireless game player attendant station 1015 and the player tracking and accounting server 1010 via network connection 1045. The wireless-only gaming machine and wireless game player server 1030 may also be connected to other remote gaming devices such as a progressive servers, cashless system servers, bonus servers, prize servers and the like.

When using a wireless-only gaming machine, the customer may use a kiosk, such as 1016 or a cashier to enter cash and provide authentication information for a wireless game play session using a wireless game player. Then, the customer may be assigned a wireless game player, such as 1020, 1021, 1022 and 1023, in communication with one of the wireless-only gaming machines 1035 or the wireless game play server 1030. Once authenticated and verified, the customer may select a game and begin playing the wireless game player. There may be wireless game play cradles in the keno parlor 1022, restaurant 1009 or Sports Book areas, allowing the customer to play their favorite casino machine game and at the same time make keno or Sports Book bets or eat. In addition, the wireless game play cradles may be used to charge batteries on the wireless game player and may also be used to provide an additional network access point such as through a wire connection provided on the cradle. The wireless game player may also be used for Sports Book and Keno betting. Thus, a player may watch a horserace or see the results of a certain event on the display of the wireless game player.

Finally, the wireless game player may also be used for other activities besides gaming. For example, because of the authentication and verification (security) features, the wireless game player could be safe way to conduct monetary transactions such as electronic funds transfers. As another example, the wireless game player may be used for video teleconferencing to visually connect to a casino host or to provide instant messaging services. In addition, when the wireless game player supports web-based browsers and the wireless game play network includes Internet access, the wireless game player may be used to obtain any web-based services available over the Internet.

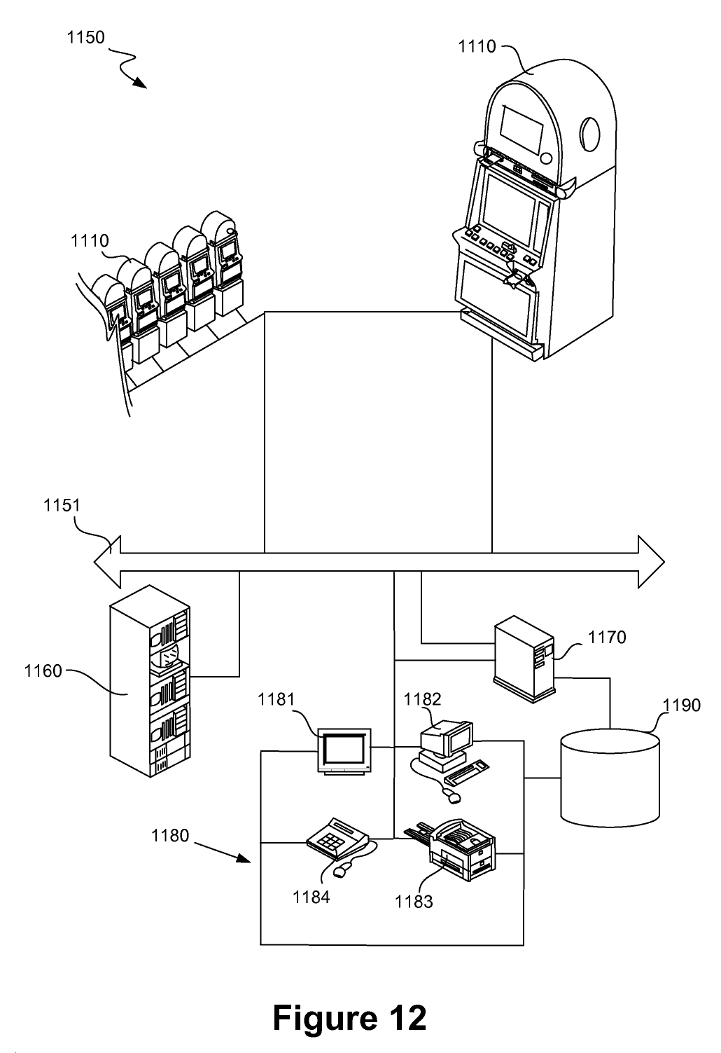

Referring now to FIG. 12, an exemplary network infrastructure for providing a gaming system having one or more gaming machines is illustrated in block diagram format. Exemplary gaming system 1150 has one or more gaming machines, various communication items, and a number of host-side components and devices adapted for use within a gaming environment. As shown, one or more gaming machines 1110 adapted for use in gaming system 1150 can be in a plurality of locations, such as in banks on a casino floor or standing alone at a smaller non-gaming establishment, as desired. Common bus 1151 can connect one or more gaming machines or devices to a number of networked devices on the gaming system 1150, such as, for example, a general-purpose server 1160, one or more special-purpose servers 1170, a sub-network of peripheral devices 1180, and/or a database 1190.

A general-purpose server 1160 may be one that is already present within a casino or other establishment for one or more other purposes beyond any monitoring or administering involving gaming machines. Functions for such a general-purpose server can include other general and game specific accounting functions, payroll functions, general Internet and e-mail capabilities, switchboard communications, and reservations and other hotel and restaurant operations, as well as other assorted general establishment record keeping and operations. In some cases, specific gaming related functions such as cashless gaming, downloadable gaming, player tracking, remote game administration, video or other data transmission, or other types of functions may also be associated with or performed by such a general-purpose server. For example, such a server may contain various programs related to cashless gaming administration, player tracking operations, specific player account administration, remote game play administration, remote game player verification, remote gaming administration, downloadable gaming administration, and/or visual image or video data storage, transfer and distribution, and may also be linked to one or more gaming machines, in some cases forming a network that includes all or many of the gaming devices and/or machines within the establishment. Communications can then be exchanged from each adapted gaming machine to one or more related programs or modules on the general-purpose server.

In one embodiment, gaming system 1150 contains one or more special-purpose servers that can be used for various functions relating to the provision of cashless gaming and gaming machine administration and operation under the present methods and systems. Such a special-purpose server or servers could include, for example, a cashless gaming server, a player verification server, a general game server, a downloadable games server, a specialized accounting server, and/or a visual image or video distribution server, among others. Of course, these functions may all be combined onto a single specialized server. Such additional special-purpose servers are desirable for a variety of reasons, such as, for example, to lessen the burden on an existing general-purpose server or to isolate or wall off some or all gaming machine administration and operations data and functions from the general-purpose server and thereby increase security and limit the possible modes of access to such operations and information.

Alternatively, exemplary gaming system 1150 can be isolated from any other network at the establishment, such that a general-purpose server 1160 is essentially impractical and unnecessary. Under either embodiment of an isolated or shared network, one or more of the special-purpose servers are preferably connected to sub-network 1180, which might be, for example, a cashier station or terminal. Peripheral devices in this sub-network may include, for example, one or more video displays 1181, one or more user terminals 1182, one or more printers 1183, and one or more other input devices 1184, such as a ticket validator or other security identifier, among others. Similarly, under either embodiment of an isolated or shared network, at least the specialized server 1170 or another similar component within a general-purpose server 1160 also preferably includes a connection to a database or other suitable storage medium 1190. Database 1190 is preferably adapted to store many or all files containing pertinent data or information regarding cashless instruments such as tickets, among other potential items. Files, data and other information on database 1190 can be stored for backup purposes, and are preferably accessible at one or more system locations, such as at a general-purpose server 1160, a special purpose server 1170 and/or a cashier station or other sub-network location 1180, as desired.

While gaming system 1150 can be a system that is specially designed and created new for use in a casino or gaming establishment, it is also possible that many items in this system can be taken or adopted from an existing gaming system. For example, gaming system 1150 could represent an existing cashless gaming system to which one or more of the inventive components or program modules are added. In addition to new hardware, new functionality via new software, modules, updates or otherwise can be provided to an existing database 1190, specialized server 1170 and/or general-purpose server 1160, as desired. In this manner, the methods and systems of the present invention may be practiced at reduced costs by gaming operators that already have existing gaming systems, such as an existing EZ Pay® or other cashless gaming system, by simply modifying the existing system. Other modifications to an existing system may also be necessary, as might be readily appreciated.

The various aspects, features, embodiments or implementations of the invention described above can be used alone or in various combinations.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computing system for providing input to an execution instance of computer program code for a computer program, wherein said input is initially received via an input device configured for receiving input when said execution instance of said computer program is executed, wherein said computing system comprises one or more processors capable of, configured and/or operable to:
receive, identify and/or determine a state of execution for said execution instance of said computer program;
receive, identify and/or determine, based on said state of execution of said execution instance, one or more discrete locations of said input device as the only one or more selected input locations for receiving input for said execution instance when said execution instance is in said state of execution, thereby effectively ignoring all other locations of said input device with respect to input that may be provided via said input device when said execution instance is in said state of execution; and
cause input received at said one or more selected input locations of said input device to be provided as input to said execution instance of said computer program code when input is received at said one or more selected input locations.

2. A computing system as recited in claim 1, wherein said one or more processors are further capable of, configured and/or operable to
effectively monitor only said or more selected input locations of said input device for input for receiving input for said execution instance when said execution instance is in said state of execution;
determine, based on said monitoring, whether input has been received at said one or more selected input locations of said integrated input device; and
effectively provide said input for processing by said execution instance of said computer program code when said determining determines that input has been received at said one or more selected input locations of said input device.

3. A computing system as recited in claim 1, wherein said execution instance of said computer program code is executed at least partly by said computing system.

4. A computing system as recited in claim 1, wherein said execution instance of said computer program code is executed at least partly by one or more other computing systems.

5. A computing system as recited in claim 1, wherein said execution instance of said computer program code is executed jointly by said computing system and one or more other computing systems.

6. A computing system as recited in claim 1, wherein said input device is configured as an integrated input/output device for said computing system.

7. A computing system as recited in claim 1, wherein said input device is configured as an integrated input/output device for one or more other computing systems that effectively communicate with said execution instance via said computing system.

8. A computing system as recited in claim 1,
wherein said input device is a visually-based integrated input/output device, and
wherein said input can be provided and received at said one or more selected input locations in connection with output displayed by said visually-based integrated input/output device when said execution instance is in said execution state.

9. A computing system as recited in claim 8, wherein said output is displayed at said one or more selected input locations and/or a determined proximity of said one or more selected input locations when said execution instance is in said execution state.

10. A computing system as recited in claim 2,
wherein said input device is a visually-based integrated input/output device; and
wherein said monitoring of said one or more selected input monitoring locations includes: visually detecting whether a physical object has effectively been provided as input at any one of said one or more selected input locations.

11. A computing system as recited in claim 1, wherein said state of execution is determined based on a state machine associated with said execution instance.

12. A computing system as recited in claim 1, wherein said computer program code includes computer program code for a game.

13. A computing system as recited in claim 12, wherein said game is a game of chance.

14. A computing system as recited in claim 12, wherein said computing system is and/or includes one or more of the following:
a gaming machine; and
a gaming server that serves one or more gaming machines.

15. A computing system as recited in claim 2, wherein said visually detecting of whether a physical object has been effectively provided as input at any one of said one or more selected input monitoring locations includes:
determining whether a physical object is within a determined proximity of said one or more selected input monitoring locations of said visually-based integrated input/output device.

16. A computing system as recited in claim 15, wherein said determining of whether a physical object is within a determined proximity of said one or more selected input monitoring locations of said visually-based integrated input/output device includes one or more of the following:
determining whether any physical object is within said determined proximity of said one or more selected input monitoring locations;
determining whether a physical object of a determined and/or acceptable form is within said determined proximity of said one or more selected input monitoring locations;
determining whether an encoded physical object is within said determined proximity of said one or more selected input monitoring locations;

17. A computing system as recited in claim 15, wherein said visually-based integrated input/output device is and/or includes a touch-screen.

18. A computing system as recited in claim 15, wherein said touch screen is a multi-touch screen capable of receiving multiple touch.

19. A computing system as recited in claim 15, wherein said visually detecting includes detecting a disturbance in a controlled Inferred Red (IR) light emitted effectively for said one or more selected input locations.

20. A computing system as recited in claim 15,
wherein said controlled IR is emitted by an IR source tuned to emit IR light in a particular frequency or a range of frequencies,
wherein said disturbance is detected by a camera effectively tuned for said particular frequency or a range of frequencies, and
wherein a visible light filter is configured for said camera in order to effectively avoid capturing visible and/or non-IR light by said camera.

21. A computing system as recited in claim 15, further comprising:
a rear-projection system configured to project images on said multi-touch screen.

22. A computing system as recited in claim 21, wherein said rear-projection system comprises:
a projector configured to project images on said multi-touch screen; and
an IR filter configured to block IR light projected by said projector.

23. A computing system as recited in claim 22, wherein said lens is made of plastic and/or glass.

24. A computing system as recited in claim 15, wherein said multi-touch screen is and/or includes a wedge-display configured to display and receive input effectively on the same surface.

25. A computing system as recited in claim 15, wherein said multi-touch screen is and/or includes a LCD display configured to display images on a LCD display and receive input on said LCD display.

26. A computing system as recited in claim 15, wherein an IR source is emitted controlled IR light in a manner the effectively traps the IR light inside the input surface of the input device, whereby a physical object that comes the touches and/or comes in close proximity of said input surface causes the controlled IR trapped inside said input surface to be deflect effectively out of said surface, thereby allowing the controlled IR to be captured by an IR capturing device.

27. A computing system as recited in claim 15,
wherein said IR source emits said controlled IR light from a side of said input surface in a manner that causes the controlled IR light to be effectively reflected inside said input surface, and
wherein said IR capturing device is a camera and a visible light filter is configured for said camera to effectively avoid capturing visible and/or non-IR light by said camera

28. A computing system as recited in claim 1,
wherein said input device is capable of receiving multiple input; and
wherein said computing system is further capable, configured and/or operable to cause a first input of said multiple input associated with a first selected input location of said selected input locations to be provided as input to said execution instance of a computer program.

29. A computing system as recited in claim 28, wherein said computing system is further capable, configured and/or operable to cause a second input of said multiple input associated with a second selected input location of said selected input locations to be provided as input to said execution instance of a computer program.

30. A computing system as recited in claim 24, wherein said computing system is further capable, configured and/or operable to cause a third input of said multiple input not to be provided as input to said execution instance of a computer program, wherein said third input is received at a third location of said integrated input/output device which is not one of said selected input locations and therefore effectively ignored as input.

31. A computing system as recited in claim 1,
wherein said input device is capable of receiving multiple input; and
wherein said computing system is further capable, configured and/or operable to cause selected input associated with two or more selected input locations of said input device to be provided as multiple input to said execution instance of said computer program; and
wherein said computing system is further capable, configured and/or operable to cause non-selected input associated with one or more non-selected input locations of said input device to be effectively ignored as input for said execution instance of said computer program.

32. A computing system as recited in claim 31, wherein said selected input associated with two or more selected input locations of said integrated input-output device are received simultaneously, at the same time and/or in an overlapping manner.

33. A computing system as recited in claim 1,
wherein said input device is a visually-based integrated input-output device; and
wherein said computing system is further capable of, configured and/or operable to:
receive, identify and/or determine graphics data representing a visual picture of said integrated input-output device;
determine based on said one or more selected input locations of said, one or more selected data portions of said graphics data respectively corresponding to said one or more selected input locations visually-based integrated input-output device;
determining based on said one or more selected data portions whether a physical object has been provided as input at said one or more selected input locations.

34. A computing system as recited in claim 33,
wherein said visually-based input-output device is and/or includes a touch-screen;
wherein said graphics data is associated with Inferred (IR) light captured as IR graphics data; and
wherein said determining of whether a physical object has been provided as input at said one or more selected input locations comprises comparing said IR graphics data with IR base data to detect a change indicating the presence of a physical object, wherein said IR base data represents a state where no input is provided to said touch-screen.

35. A computing system as recited in claim 34, wherein said comparing of said IR graphics data comprises: detecting a change in contrast ratio.

36. A computing system as recited in claim 33,
wherein said visually-based input-output device is and/or includes a touch-screen;
wherein said computing system is capable of, configured and/or operable:
to detect a disturbance in a controlled Inferred (IR) light emitted for said one or more selected input locations of said touch-screen, wherein said disturbance can effectively detect a physical object provided as input at said one more selected input locations.

37. A method for providing input to an execution instance of computer program code for a computer program, wherein said input is initially received via an input device configured for receiving input when said execution instance of said computer program is executed, wherein said method comprises:
receiving, identifying and/or determining a state of execution for said execution instance of said computer program;
receiving, identifying and/or determining, based on said state of execution of said execution instance, one or more discrete locations of said input/device as the only one or more selected input locations for receiving input for said execution instance when said execution instance is in said state of execution, thereby effectively ignoring all other locations of said input device with respect to input that may be provided via said input device when said execution instance is in said state of execution; and
causing input received at said one or more selected input locations of said input device to be provided as input to said execution instance of said computer program code when input is received at said one or more selected input locations.

38. A computer readable medium including computer program code for providing input to an execution instance of computer program code for a computer program, wherein said input is initially received via an input device configured for receiving input when said execution instance of said computer program is executed, wherein said computer readable medium comprises:
computer program code for receiving, identifying and/or determining a state of execution for said execution instance of said computer program;
computer program code for receiving, identifying and/or determining, based on said state of execution of said execution instance, one or more discrete locations of said input/device as the only one or more selected input locations for receiving input for said execution instance when said execution instance is in said state of execution, thereby effectively ignoring all other locations of said input device with respect to input that may be provided via said input device when said execution instance is in said state of execution; and
computer program code for causing input received at said one or more selected input locations of said input device to be provided as input to said execution instance of said computer program code when input is received at said one or more selected input locations.

39. A computer implemented method for providing input to an execution instance of a computer program, wherein said input is initially received via an input device configured for receiving input when said execution instance of said computer program is executed, said method comprising:
determining, receiving and/or identifying Inferred (IR) graphics data pertaining to a controlled IR light emitted for said input device;
receiving, identifying and/or determining a state of execution for said execution instance of said computer program;
receiving, identifying and/or determining, based on said state of execution of said execution instance, one or more discrete locations of said input/device as the only one or more selected input locations for receiving input for said execution instance when said execution instance is in said state of execution;
determining, based on said one or more selected input locations, one or more data portions of said IR graphics data for detection of input;
determining, based on said one or more data portions of said IR graphics data, whether one or more physical objects have been provided as input at said one or more selected input locations; and
causing input to be provided to said execution instance when said determining determines that said one or more physical objects have been provided as input at said one or more selected input locations.

40. A computer readable medium including computer program code for providing input to an execution instance of a computer program, wherein said input is initially received via an input device configured for receiving input when said execution instance of said computer program is executed, wherein said computer readable medium comprises:
computer program code for determining, receiving and/or identifying Inferred (IR) graphics data pertaining to a controlled IR light emitted for said input device;
computer program code for receiving, identifying and/or determining a state of execution for said execution instance of said computer program;
computer program code for receiving, identifying and/or determining, based on said state of execution of said execution instance, one or more discrete locations of said input/device as the only one or more selected input locations for receiving input for said execution instance when said execution instance is in said state of execution;
computer program code for determining, based on said one or more selected input locations, one or more data portions of said IR graphics data for detection of input;
computer program code for determining, based on said one or more data portions of said IR graphics data, whether one or more physical objects have been provided as input at said one or more selected input locations; and
computer program code for causing input to be provided to said execution instance when said determining determines that said one or more physical objects have been provided as input at said one or more selected input locations.
